(19) United States
(12) Patent Application Publication
(10) Pub. No.: US 2013/0111036 A1
(43) Pub. Date: May 2, 2013

(54) MANAGEMENT METHOD FOR NETWORK SYSTEM, NETWORK SYSTEM, AND MANAGEMENT SERVER

(71) Applicants: Yoji Ozawa, Tokyo (JP); Eri Kawai, Yokohama (JP); Akihiro Koizumi, Kawasaki (JP); Yoshiko Yasuda, Tokorozawa (JP); Yosuke Himura, Tokyo (JP)

(72) Inventors: Yoji Ozawa, Tokyo (JP); Eri Kawai, Yokohama (JP); Akihiro Koizumi, Kawasaki (JP); Yoshiko Yasuda, Tokorozawa (JP); Yosuke Himura, Tokyo (JP)

(73) Assignee: HITACHI, LTD., Tokyo (JP)

(21) Appl. No.: 13/568,659

(22) Filed: Aug. 7, 2012

(30) Foreign Application Priority Data
Oct. 27, 2011 (JP) 2011-236407

(51) Int. Cl. G06F 15/173

(52) U.S. Cl. 709/226

(57) ABSTRACT

A management method for a network system, the method comprising: acquiring, by the management server, a physical composition element and a virtual composition element of the computer resource and generating device information and a physical connection of the computer resource and a virtualized connection and generating connection information; receiving, tenant patterns for holding a template of a configuration item for each logical node, a parameter of the configuration item, a definition for calculating the parameter, and storing the plurality of tenant patterns; storing, mapping information in which a correlation between a node of each of the plurality of tenant patterns and a composition element of the device information; receiving, an input of the plurality of tenant patterns and a type of an operation; selecting, the composition element of the device information for each node; generating, configuration contents of a network.

### CLAIM OF PRIORITY

The present application claims priority from Japanese patent application NO. 2011-236407 filed on Oct. 27, 2011, the entire contents of which are hereby incorporated by reference into the application.

### BACKGROUND

The subject matter disclosed in this specification relates to a network system, a management server, and an automatic design/configuration management method, in particular, a network system, a management server, and an automatic design/configuration management method for collectively designing and configuring a network configuration item for a tenant.

In recent years, more and more companies use a cloud service in order to quickly handle business environments experiencing drastic changes and cutbacks in cost of owning IT resources. One of key features of the cloud service is “to provide a service on demand”. In most cases, the cloud service is provided by a data center (hereinafter, referred to as “DC”), but in order to realize this feature, an IT system needs to have a composition modified frequently. A network serving as a part of the IT system similarly needs to be designed and configured for a composition modification frequently. It sufficed that the network had a fixed composition before the cloud service is provided, and hence a daily operator of the DC has a poor skill for designing/configuring the network. Therefore, in the DC that provides the cloud service, it is difficult for the daily operator to design/configure the network. An operation cost for the DC becomes higher if the daily operator is to be educated to design or configure the network or if an operator skilled in the network is to be newly posted.

One of approaches to solving this problem is a method of automating design or configuration work for the network. Specifically, as disclosed in, for example, paragraph 0034 of Japanese Patent Application Laid-open No. 2010-224977 (hereinafter, referred to as Document 1), there is known a method involving converting configuration contents into a template for each operation flow (newly adding a tenant, modifying an access control list (ACL) of an existing tenant, adding a virtual machine (VM), or the like). The operator calculates only a parameter in performing an operation for designing or configuring the network, while a management system substitutes the calculated parameter into a template and generates configuration contents to be set for a network device.

### SUMMARY

In the methods disclosed in Document 1, as described, not only the design or configuration of the network but also an operation flow for controlling various systems is defined as a template, and execution of the operation flow is automated in accordance with the template in performing the configuration.

However, the method according to the above-mentioned conventional example raises a problem in that templates grow in number and it is cumbersome to generate, maintain, and customize the templates.

A description is made of the number of templates used for the design or configuration of the network. The composition of the tenant has several types in one DC, and a different composition is used in a different DC. In addition, there are a plurality of operation flows for each tenant, which means that the required number of templates is (number of tenants)×(number of operation flows). Further, if a physical device differs between tenants having substantially the same composition due to load balancing, different templates need to be used, which increases the number of templates.

If the number of templates is large, it is extremely cumbersome to generate templates when the network and virtual machines are initially built. Further, after a service is started in the DC, it is necessary to modify all relating templates to modify a physical composition, a tenant composition, or an operation flow, which leads to a problem of an increase in cost required for work. There is another problem in that an omission or an error is likely to occur in a description in a case where an administrator or the like manually performs modifications of a large number of templates.

In view of the above-mentioned problems, this specification discloses a technology for automating design or configuration of a network without generating a large number of templates to facilitate initial configuration and maintenance of a management system.

Accordingly, a daily operator can easily design or configure the network even without being skilled in the network, which can reduce an operation cost.

A representative aspect of the present disclosure is as follows. A management method for a network system, the network system comprising: a network device for transferring a packet; a physical server connected to the network device; and a management server, which includes a processor and a storage device and is connected to the physical server via the network device, the management method being performed to allocate computer resources comprising the network device and the physical server to a plurality of tenants, the management method comprising: a first step of acquiring, by the management server, a physical composition element and a virtual composition element of the computer resource and generating device information; a second step of acquiring, by the management server, a physical connection of the computer resource and a virtualized connection and generating connection information; a third step of receiving, by the management server, a plurality of tenant patterns for holding a template of a configuration item for each logical node, a parameter of the configuration item, a definition for calculating the parameter, and a command, and storing the plurality of tenant patterns in the storage device; a fourth step of storing, by the management server, mapping information in which a correlation between a node of each of the plurality of tenant patterns and a composition element of the device information is configured, in the storage device; a fifth step of receiving, by the management server, an input of the plurality of tenant patterns and a type of an operation; a sixth step of selecting, by the management server, the composition element of the device information for each node from the plurality of input tenant patterns and the mapping information; a seventh step of generating, by the management server, configuration contents of a network from the plurality of input tenant patterns and the selected composition element; an eighth step of acquiring, by the management server, the definition for calculating the parameter for the each node from the plurality of input tenant patterns, calculating the parameter for the each node, and generating configuration contents of the each node; and a ninth step of configuring, by the management server, the generated configuration contents of the network and the generated configuration contents of the each node, for the selected composition element.

According to the above-mentioned aspect, the design or configuration of the network is automated when the tenant pattern and the type of the operation are input to the management server, and hence there is no need to generate a template for each tenant, which allows even a daily operator having poor skills in the network to perform design for a composition modification of the network, while an operation error is prevented to allow accurate configuration, which allows a cloud service or the like to be provided with stability. In addition, with the tenant pattern, a pattern of the tenant can be defined by a logical composition, and hence there is no need for detailed configuration, which can reduce time and labor. In addition, by using mapping information, the mapping of the computer resource to the node can be made flexible, which allows one tenant pattern to handle the composition of the plurality of tenants and facilitates generation of configuration and maintenance.

According to the teaching herein, it is possible to automate design/configuration based on the tenant pattern and the type of the operation, and to facilitate the operator's work. Further, it is possible to define the pattern of the tenant by a logical composition, and to reduce time and labor for the generation and maintenance.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 exemplifies a block diagram illustrating a composition of a network system according to a first embodiment.

FIG. 2 exemplifies a block diagram of the management server 500 according to the first embodiment.

FIG. 3 exemplifies a conceptual diagram of the tenant pattern information according to the first embodiment.

FIG. 4 exemplifies a diagram of the tenant pattern information (node) according to the first embodiment.

FIG. 5 exemplifies a diagram of the tenant pattern information (subnet) according to the first embodiment.

FIG. 6 exemplifies a diagram of the mapping information according to first embodiment.

FIG. 7 exemplifies a diagram of the ID pool information according to the first embodiment.

FIG. 8 exemplifies a diagram of the command template information according to the first embodiment.

FIG. 9 exemplifies a diagram of the tenant instance information (node) according to the first embodiment.

FIG. 10 exemplifies a diagram of the tenant instance information (subnet) according to the first embodiment.

FIG. 11 exemplifies a diagram of the tenant instance information (mapping) according to the first embodiment.

FIG. 12 exemplifies a diagram of the composition information according to the first embodiment.

FIG. 13 exemplifies a diagram of the connection information 530 according to the first embodiment.

FIG. 14 exemplifies a diagram of the ring composition information (redundant network information) according to the first embodiment.

FIG. 15 exemplifies a diagram of the design/configuration task information according to the first embodiment.

FIG. 16 exemplifies a diagram of the scheduling information 533 according to the first embodiment.

FIG. 17 exemplifies a diagram of a user interface according to the first embodiment.

FIG. 18 exemplifies a screen image of a user interface according to the first embodiment.

FIG. 19 exemplifies a screen image of a user interface defines the subnet of the tenant pattern according to the first embodiment.

FIG. 20 exemplifies a sequence diagram used at a time of initial introduction of the management server according to the first embodiment.

FIG. 21 exemplifies a diagram illustrating a message transmitted/received at the time of the initial introduction of the management server according to the first embodiment.

FIG. 22 exemplifies a sequence diagram of adding the tenant during the operation of the first embodiment.

FIG. 23 exemplifies a diagram illustrating a message transmitted/received when the network according to the first embodiment.

FIG. 24 exemplifies a flowchart of mapped device selection processing according to the first embodiment.

FIG. 25 exemplifies a flowchart of subnet concretion processing according to the first embodiment.

FIG. 26 exemplifies a flowchart of parameter calculation/configuration contents generation processing according to the first embodiment.

FIG. 27 exemplifies a sequence diagram used at a time of modifying the existing tenant (adding the VM) during the operation of a second embodiment.

FIG. 28 exemplifies a diagram illustrating a message transmitted/received at the time of the network design and configuration according to the second embodiment.

FIG. 29 exemplifies a flowchart of the processing for modification of the tenant under the operation flow according to the second embodiment.

FIG. 30 illustrates an example in which the items of the parameter are classified into the main class and the sub class according to the first embodiment.

### DETAILED DESCRIPTION OF THE EMBODIMENTS

Hereinafter, exemplary embodiments are described with reference to the accompanying drawings.

### First Embodiment

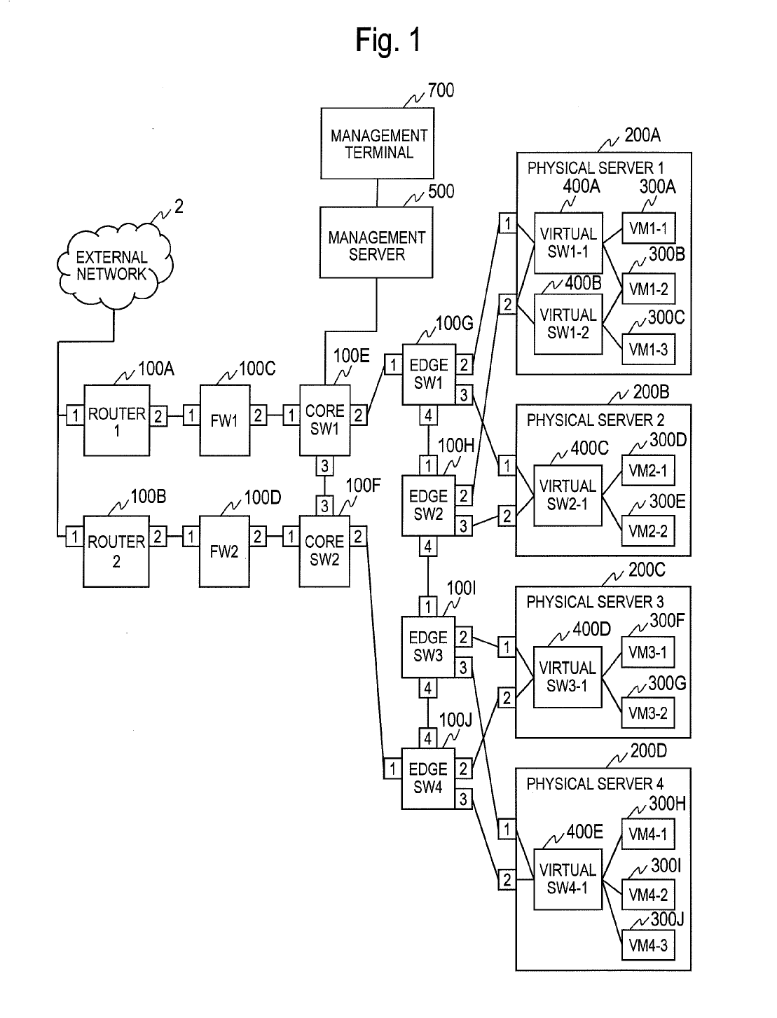

FIG. 1 is a block diagram illustrating a composition of a network system according to a first embodiment. The network system according to this embodiment includes, for example, routers 100A and 100B, firewalls (FWs) 100C and 100D, core switches (SWs) 100E and 100F, edge SWs 100G, 100H, 100I, and 100J, physical servers 200A, 200B, 200C, and 200D, the virtual SWs 400A, 400B, 400C, 400D, and 400E, virtual machines (hereinafter, referred to as “VMs”) 300A, 300B, 300C, 300D, 300E, 300F, 300G, 300H, 300I, and 300J, a management server 500, and a management terminal (operator management terminal) 700. It should be noted that, in the following description, the routers 100A and 100B, the FWs 100C and 100D, the core SWs 100E and 100F, and the edge SWs 100G, 100H, 100I, and 100J may be referred to generically as “network devices 100”.

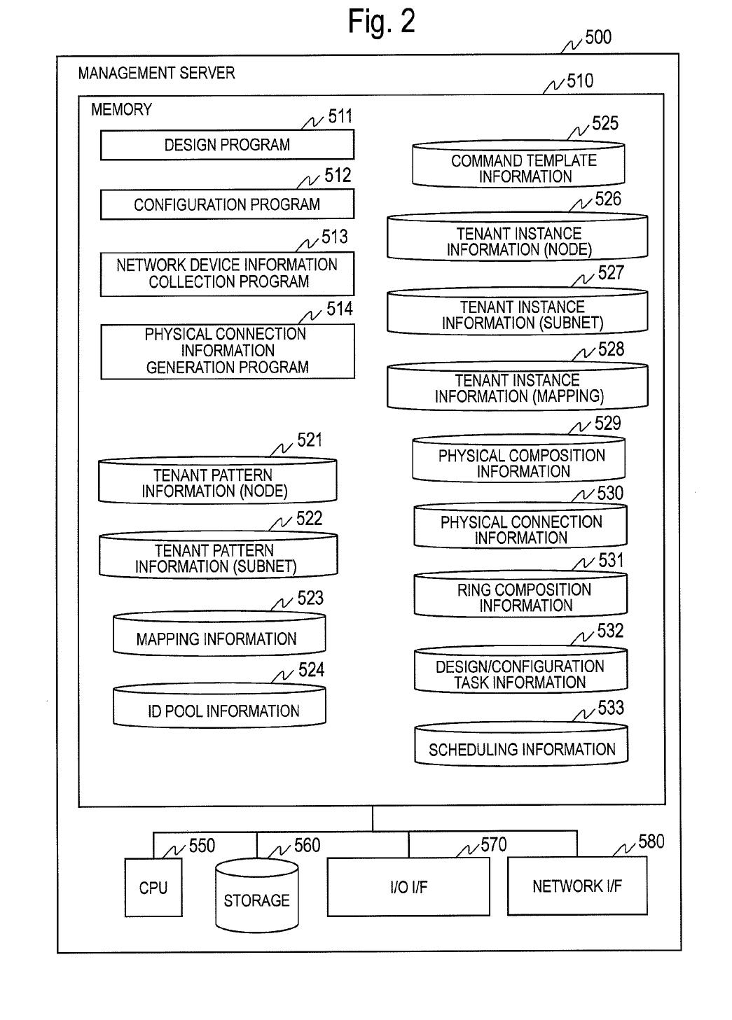

In addition, in the following description, the network devices and the physical servers 200A, 200B, 200C, and 200D (hereinafter, referred to as “physical servers 200”) may be referred to generically as “physical devices” or “physical computer resources”. Further, in this embodiment, only devices of the above-mentioned types are involved, but a load balancer or a virtual private network (VPN) device may be involved. The management server 500 is a computer for managing the network devices, the physical servers, the virtual SWs, and the VMs. It should be noted that the virtual SWs and the VMs are assumed as virtualized or logical computer resources. The management server 500 can communicate to/from the network devices, and can perform collection of device information on the network system, configuration of the network devices, the physical servers, the virtual SWs, and the VMs, and like. The routers 100A and 100B are connected to an external network 2 such as a VPN or the Internet. A network ranging from the routers 100A and 100B to the physical servers 200 or the management server 500 forms an internal network in a data center (hereinafter, referred to as “DC”). It should be noted that an external network is excluded from management targets of the management server 500. In FIG. 1, the management server 500 is connected to the network devices 100, the physical servers 200, the virtual SWs, and the VMs through a logically separate network. It should be noted that a physically different network for management may be used for the connection. The management server 500 is described later in detail referring to FIG. 2. The network devices 100 and the virtual SWs are devices for transferring information communicated within the network to a destination of the information. The physical server 200 executes a virtualization module (not shown) for generating a virtual machine VM, and operates at least one virtual machine VM on the virtualization module. Further, the virtualization module includes the virtual SW, and connects the VM on the virtualization module to the external network via the virtual SW. It should be noted that the virtualization module can be constituted by a hypervisor or a virtual machine monitor (VMM).

The management terminal 700 includes an input device constituted by a mouse and a keyboard and a display constituted by a display device, and is connected to, for example, the management server 500. An operator (or administrator) can issue various instructions from the management terminal 700 to the management server 500. It should be noted that the number of network devices 100 is not limited to the illustrated example and can be any appropriate number. Further, in FIG. 1, the numbers inside the rectangles that connect the respective devices indicate port numbers of the respective devices.

FIG. 2 is a block diagram of the management server 500 according to this embodiment. The management server 500 includes, for example, a memory 510, a processing unit (CPU) 550, a storage device 560, an I/O interface (I/F) 570, and a network interface (I/F) 580. The management server 500 transmits/receives information to/from another device (such as, for example, network device 100) connected to the internal network via the network I/F 580. Further, the I/O I/F 570 is constituted by, for example, a host bus adapter (HBA), and can be connected to a storage system (not shown) or the like.

The memory 510 stores, for example, a design program 511, a configuration program 512, a network device information collection program 513, a connection information generation program 514, tenant pattern information (node) 521, tenant pattern information (subnet) 522, mapping information 523, ID pool information 524, command template information 525, tenant instance information (node) 526, tenant instance information (subnet) 527, tenant instance information (mapping) 528, composition information 529, connection information 530, ring composition information 531, design/configuration task information 532, and scheduling information 533. It should be noted that the respective programs can be executed by the CPU 550. Further, the respective programs are stored in the storage device 560 or the like being a non-transitory memory medium, and the CPU 550 loads the program onto the memory 510 and executes the program. The CPU 550 operates in accordance with the program of each functional module, to thereby operate as a functional module for realizing a predetermined function. For example, the CPU 550 operates in accordance with the design program 511, to thereby function as a design module. The same applies to the other programs. In addition, the CPU 550 operates also as a functional module for realizing each of a plurality of processing executed by the respective programs. The programs for realizing the respective functions and information including tables can be stored in the storage device 560, a memory device such as a nonvolatile semiconductor memory, a hard disk drive, or a solid state drive (SSD), or a computer-readable non-transitory data memory medium such as an IC card, an SD card, or a DVD.

The design program 511 generates configuration contents of the network system in accordance with a tenant pattern in response to a request made by the operator (or administrator) who uses the management terminal 700. The configuration program 512 reflects configurations on the network devices 100 and the physical servers 200 based on the configuration contents generated by the design program 511. The network device information collection program 513 collects device-basis connection information and ring composition information from the network devices 100 and the physical servers 200. The connection information generation program 514 generates the connection information 530 from the information collected by the network device information collection program 513.

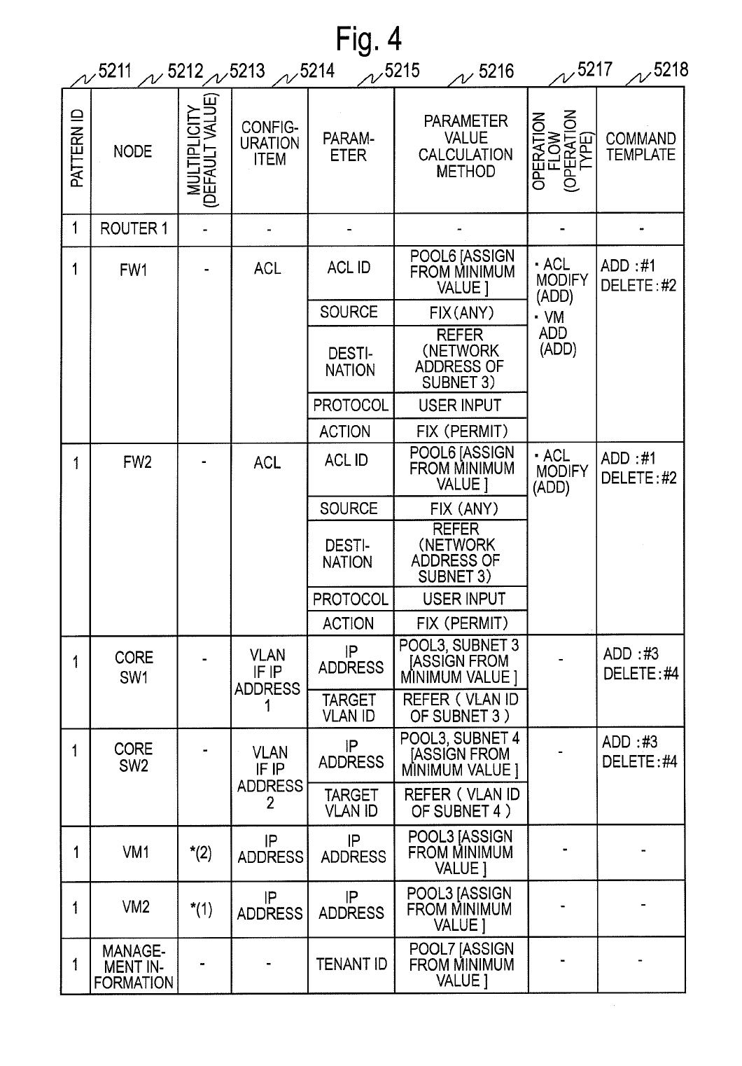

The tenant pattern information (node) 521 represents a logical composition pattern of nodes of a tenant, and manages the nodes included in the tenant pattern, parameters of the nodes, and the configuration items thereof. In other words, the tenant pattern information (node) 521 defines an internet protocol (IP) composition for each node, includes the configuration item of each node, and manages a calculation method for the parameter and an operation flow. The tenant pattern information (node) 521 can be set by the operator from the management terminal 700 or the like. The tenant pattern information (node) 521 is described later in detail referring to FIG. 4.

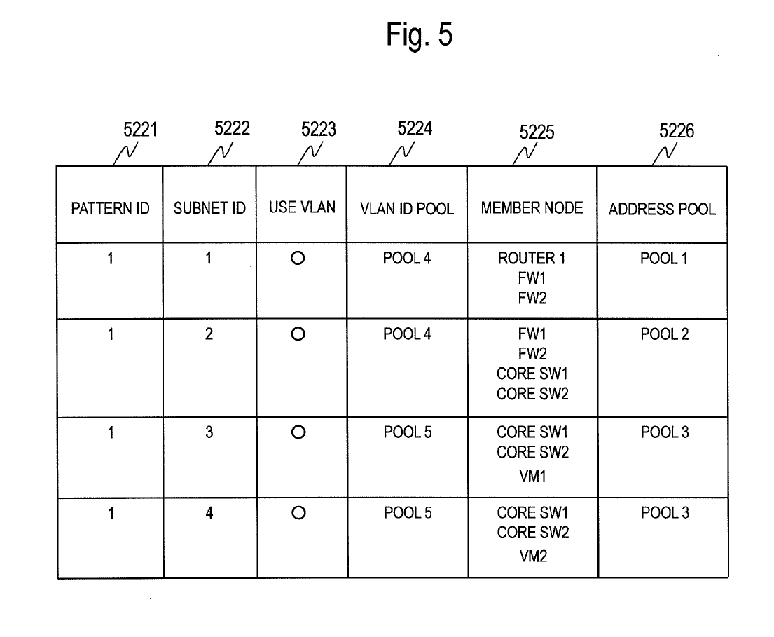

The tenant pattern information (subnet) 522 represents the composition pattern of a subnetwork (hereinafter, referred to as “subnet”) of each tenant pattern, and manages device information on the subnet of the tenant pattern. In other words, the tenant pattern information (subnet) 522 manages the device information on the node to which the subnet belongs or the like. The tenant pattern information (node) 521 can be set by the operator from the management terminal 700 or the like. The tenant pattern information (subnet) 522 is described later in detail referring to FIG. 5.

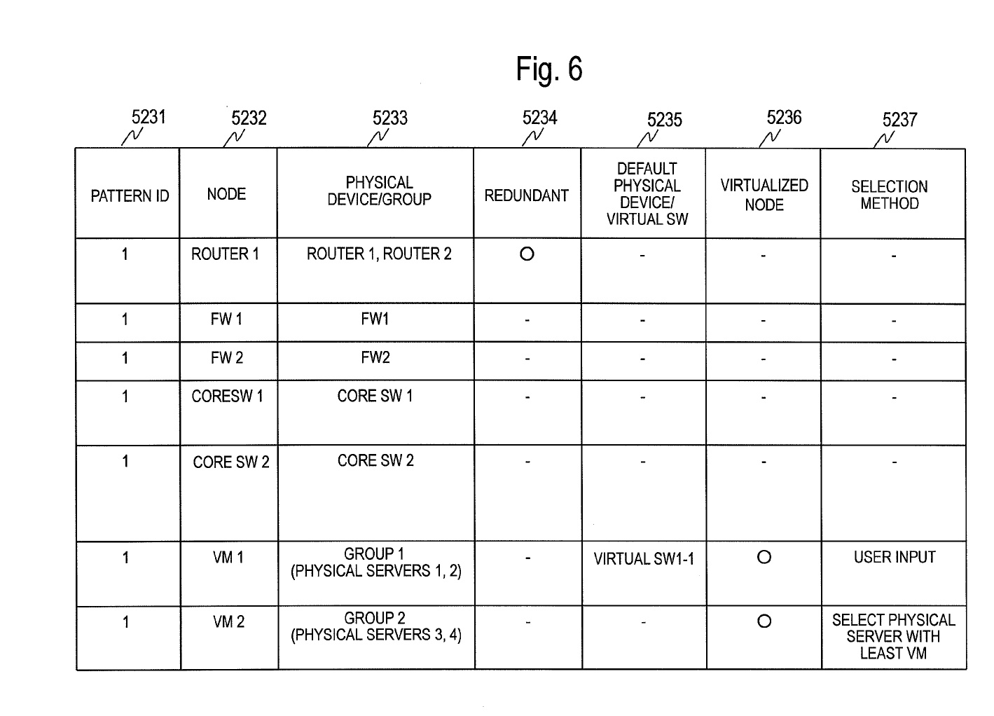

The mapping information 523 manages a type of mapping indicating a relationship between the node of the tenant pattern and a physical device or a virtual device corresponding to the node. The mapping information 523 can be set by the operator or the like from the management terminal 700. The mapping information 523 is described later in detail referring to FIG. 6.

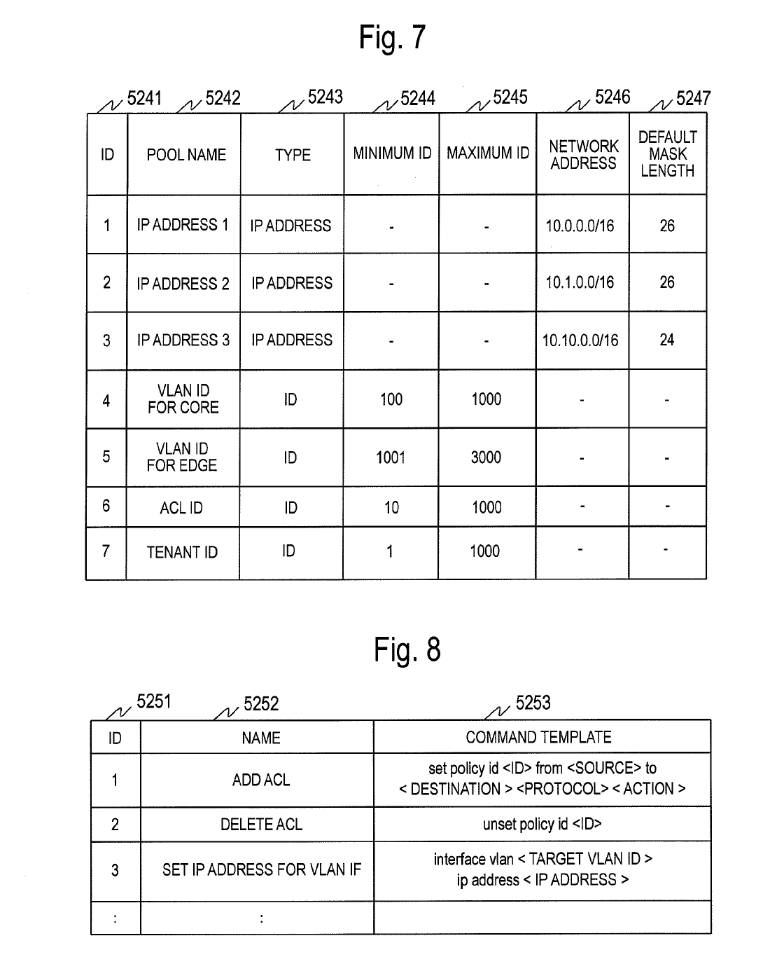

The ID pool information 524 manages information on an ID pool including addresses and identifiers assigned within the network system. The ID pool information 524 can be set by the operator from the management terminal 700 or the like. It should be noted that the ID pool information 524 is described later in detail referring to FIG. 7.

The command template information 525 manages a correlation between a name of a command referred from the tenant pattern information (node) 521 and command template information. The command template information 525 can be set by the operator from the management terminal 700 or the like. The command template information 525 is described later in detail referring to FIG. 8.

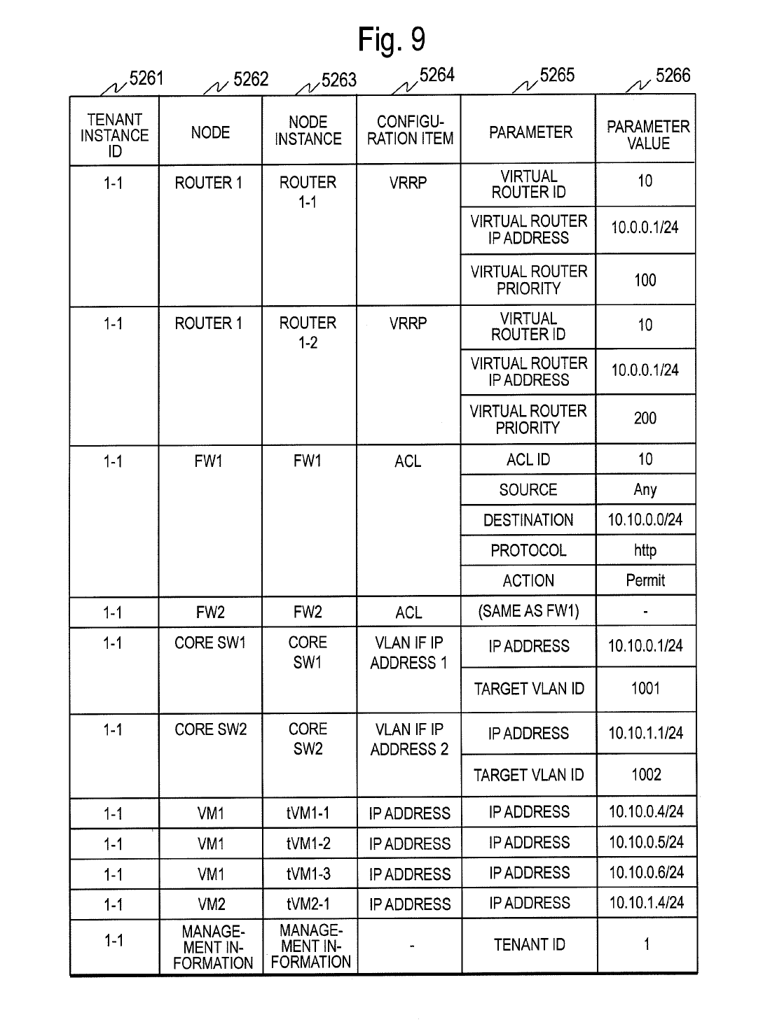

The tenant instance information (node) 526 manages information on a tenant instance relating to the node generated or updated by the design program 511. The tenant instance information (node) 526 is described later in detail referring to FIG. 9.

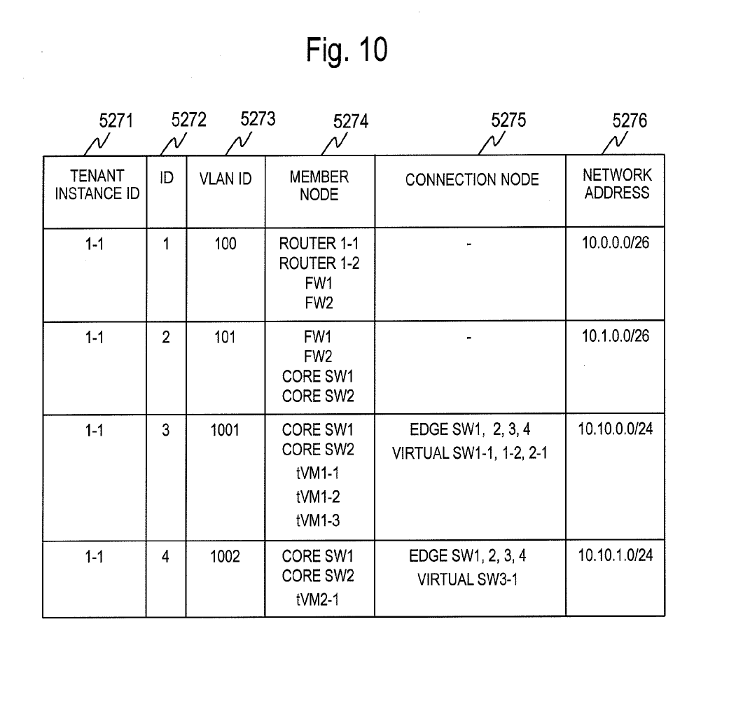

The tenant instance information (subnet) 527 manages information on the subnet within the tenant instances generated or updated by the design program 511. The tenant instance information (subnet) 527 is described later in detail referring to FIG. 10.

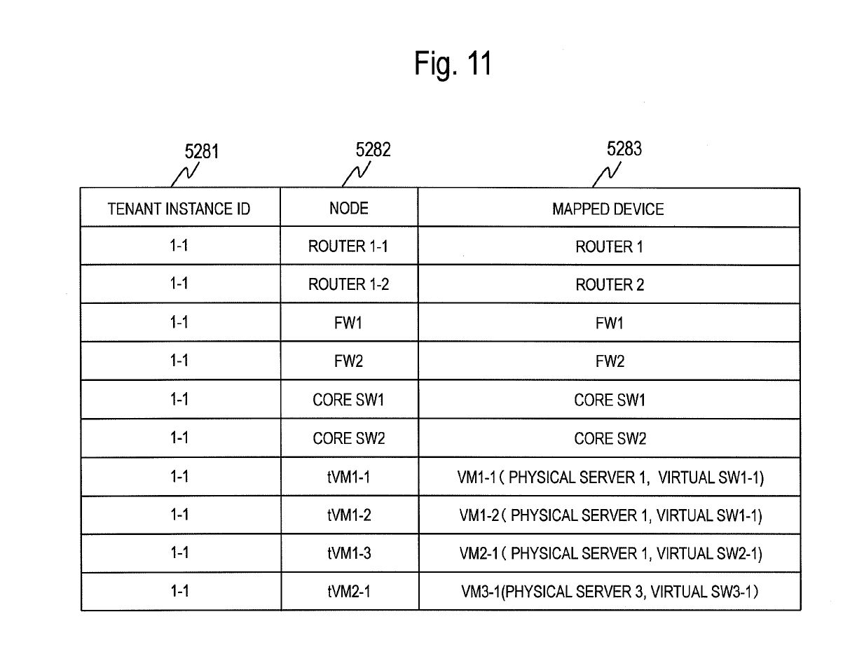

The tenant instance information (mapping) 528 manages mapping information indicating a correlation between a node and a physical device or a virtual device within the tenant instances generated or updated by the design program 511. The tenant instance information (mapping) 528 is described later in detail referring to FIG. 11.

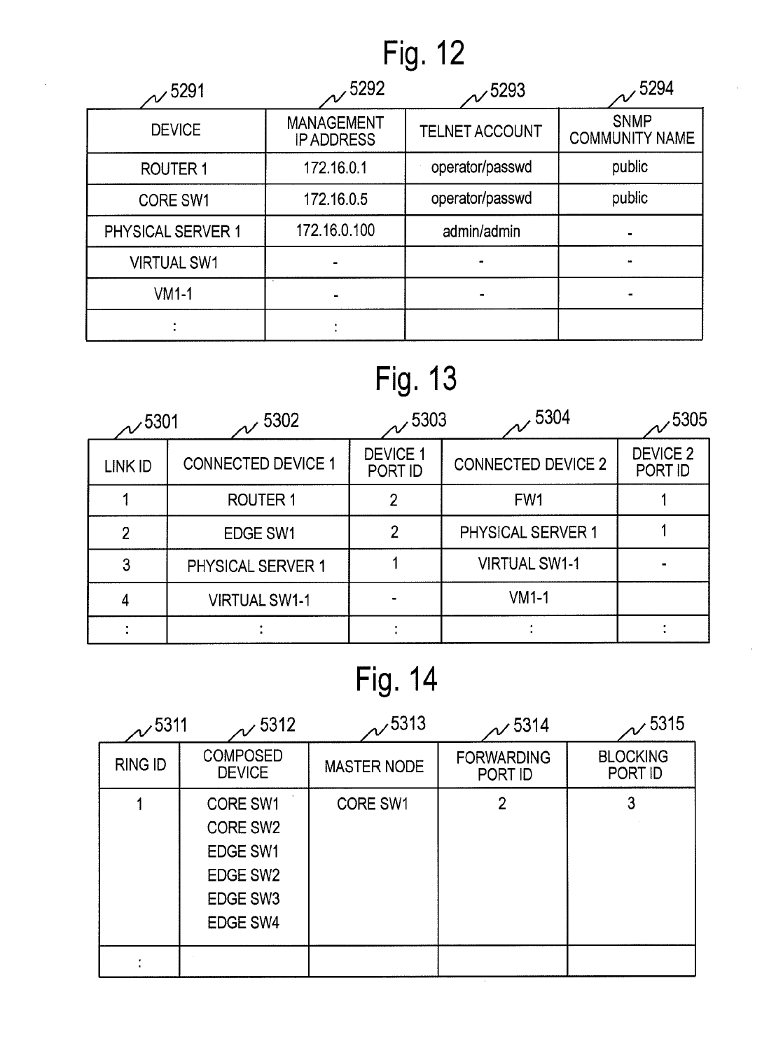

The composition information 529 manages authorization information, addresses, and the like which are necessary for the network device information collection program 513, the configuration program 512, or the like to collect or configure the information for each physical device or virtual device of the management target. The composition information 529 is described later in detail referring to FIG. 12.

The connection information 530 is generated by the connection information generation program 514, and manages the connection information between the physical devices or between the virtual devices. The connection information 530 is described later in detail referring to FIG. 13.

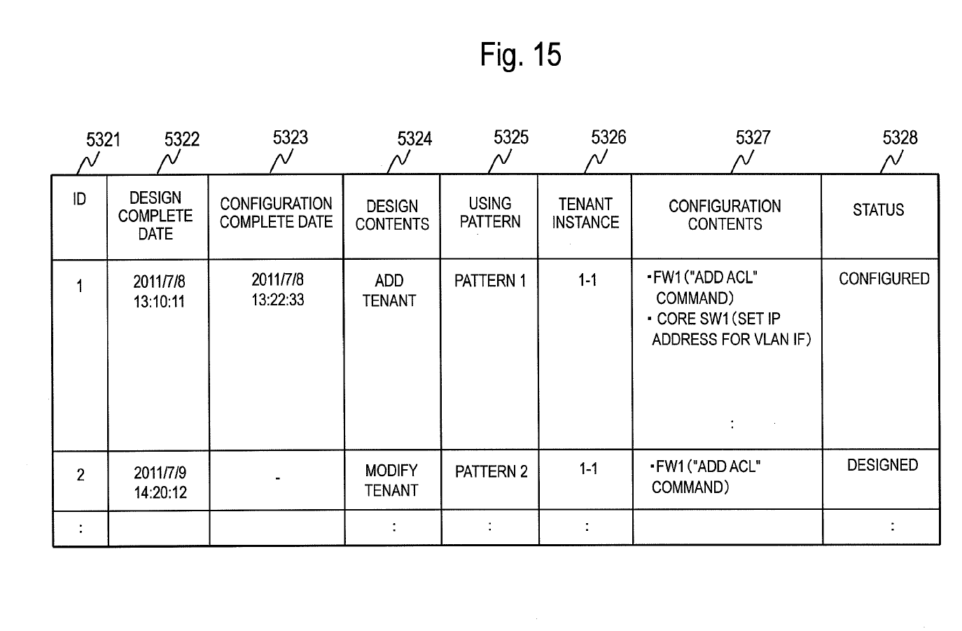

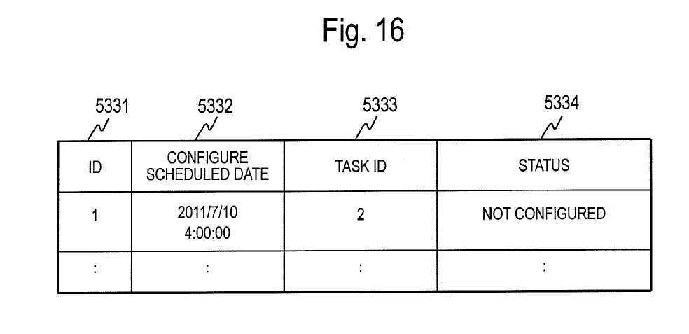

The ring composition information 531 manages the device information on a ring network composed on a plurality of physical devices (or virtual devices). The ring composition information 531 is generated by the network device information collection program 513. The ring composition information 531 is described later in detail referring to FIG. 14. The design/configuration task information 532 manages a design or configuration task including the configuration contents designed by the operator or the like. The design/configuration task information 532 is described later in detail referring to FIG. 15. The scheduling information 533 manages information used for scheduling the execution of the design or configuration task. The scheduling information 533 is described later in detail referring to FIG. 16.

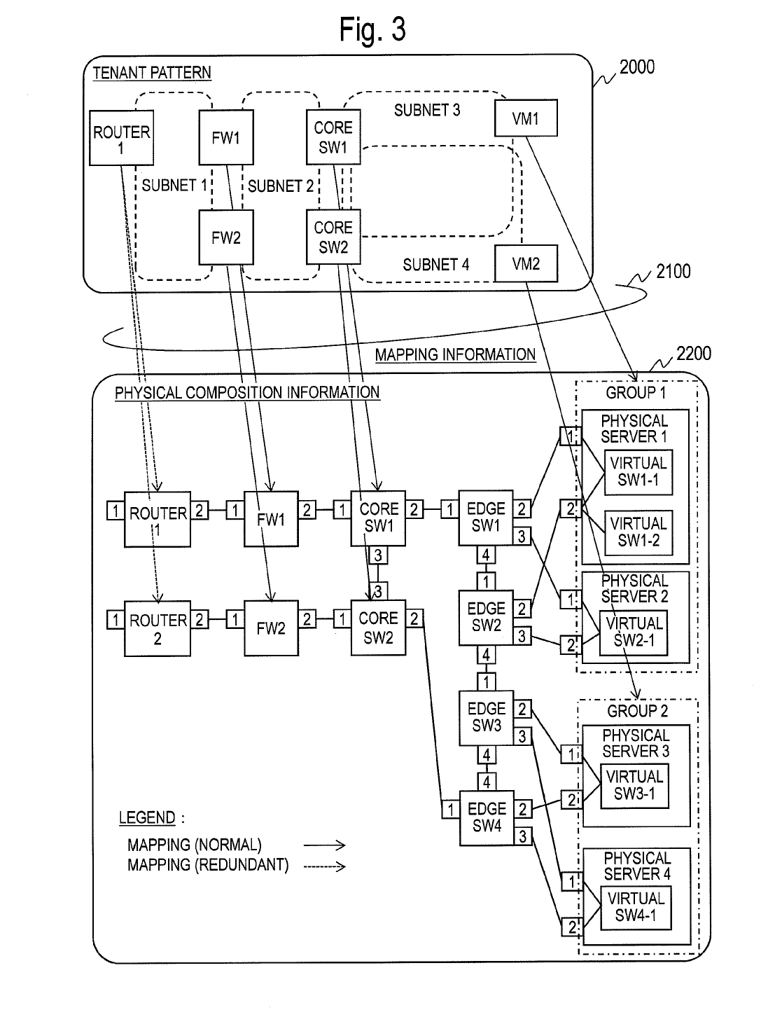

FIG. 3 is a conceptual diagram of the tenant pattern information. A tenant pattern 2000 defines the composition of a logical network system of the tenant. In other words, the tenant pattern information (node) 521 and the tenant pattern information (subnet) 522 which are illustrated in FIG. 2 compose the tenant pattern 2000. Composition information 2200 represents the composition information 529 and the connection information 530 which are collected from the physical device and the virtual device within the network system. Mapping information 2100 defines the composition information 529 corresponding to the respective nodes of the tenant pattern 2000. In other words, the mapping information 2100 corresponds to the mapping information 523 illustrated in FIG. 2.

In the network system illustrated in FIG. 1, a plurality of tenants are in operation, and one tenant (subscriber or user) uses the computer resources on the network that is logically separate from the other tenants as illustrated in FIG. 3 as in the tenant pattern 2000 and the mapping information 2100. In other words, a subnet address and a virtual network (VLAN) ID are set for each tenant, and a plurality of logically separate network systems are provided to the tenants being clients. It should be noted that the VLAN is any layer that is equal to or higher than Layer 2.

The tenant pattern 2000 illustrated in FIG. 3 includes the nodes of a router 1, an FW1, an FW2, a core SW1, a core SW2, a VM1, and a VM2. There are four subnets 1 to 4. The subnet 1 includes the router 1, the FW1, and the FW2. The subnet 2 includes the FW1, the FW2, the core SW1, and the core SW2. The subnet 3 includes the core SW1, the core SW2, and the VM1. The subnet 4 includes the core SW1, the core SW2, and the VM2. In this manner, the tenant can be defined by a logical composition by using the tenant pattern 2000 and the mapping information 2100, and hence there is no need for definitions for the devices, which produces an excellent effect of facilitating work for generating and maintaining the information for automatic design/configuration.

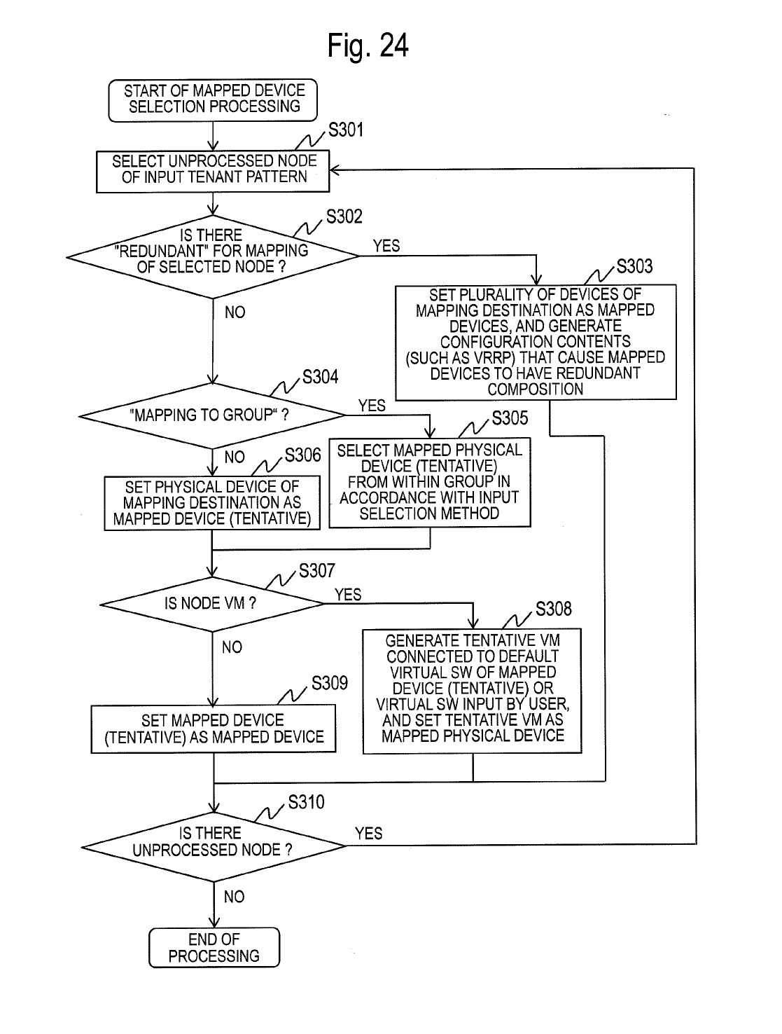

A description is made of the mapping information 2100. The router 1 is mapped to a router 1 and a router 2 of the physical devices in a state in which there is “redundant”. Processing for the mapping in the state in which there is “redundant” is described later in detail referring to FIG. 24. In FIG. 3, the FW1, the FW2, the core SW1, and the core SW2 are mapped to the FW1, the FW2, the core SW1, and the core SW2, respectively, of the physical devices. The VM1 is mapped to a group 1 formed of a physical server 1 and a physical server 2, and the VM2 is mapped to a group 2 formed of a physical server 3 and a physical server 4. It is determined at a time of design or configuration which physical device the VM is mapped to the VM on in each tenant instance. In this manner, by mapping the VM to the group of the physical servers, it is possible to define the mapping to different physical devices by using one tenant pattern 2000 and one piece of mapping information 2100. This allows reduction of the number of tenant patterns 2000 and the number of pieces of mapping information 2100, which can cut back work cost required for the maintenance such as generation and update of the tenant pattern (the tenant pattern information (node) 521 and the tenant pattern information (subnet) 522).

It should be noted that one tenant pattern 2000 is illustrated in this embodiment, but the management server 500 stores a plurality of tenant patterns. Those tenant patterns may be provided as a plurality of tenant patterns having different types of logical compositions such as, for example, a logical composition for publishing to the Internet or a logical composition for a core operation.

FIG. 4 is an explanatory diagram of the tenant pattern information (node) 521 according to this embodiment. The tenant pattern information (node) 521 has one record composed of, for example, a pattern ID 5211, a node 5212, a multiplicity (default value) 5213, a configuration item 5214, a parameter 5215, a parameter value calculation method 5216, an operation flow (operation type) 5217, and a command template 5218.

In the tenant pattern information (node) 521, as the node of the tenant, although not a network element, information (management information) for managing the tenant can be defined. Further, in the tenant pattern information (node) 521, the parameter can be defined for the management information. In the management information, the mapping is not performed to the physical devices. In FIG. 4, for example, “management information” in the last row is the management information as described above.

The pattern ID 5211 of the tenant pattern information (node) 521 is information for uniquely identifying the tenant pattern within the network system. The node 5212 is information on the node defined by the tenant pattern. The multiplicity (default value) 5213 is information indicating how many nodes in the same positions within the respective tenants (nodes belonging to the same subnet and having the same configuration item and the same parameter) are generated. When the value of the multiplicity (default value) 5213 is “-”, this type of node is assumed as one. On the other hand, when the value of the multiplicity (default value) 5213 is “*”, a plurality of nodes can be generated. Further, the default value can be defined as the number of nodes. For example, in FIG. 4, for the VM1, two nodes can be generated as a default. When the operator inputs the number of nodes, the input number of nodes are generated. When the operator does not input the number of nodes, the nodes the number of which is designated by the default value 5213 are generated.

The configuration item 5214 stores information indicating the type of information to be configured for the node. The parameter 5215 is information indicating the item of the parameter of the node. It should be noted that the parameter can be used for a plurality of configuration items within the node. The parameter value calculation method 5216 stores a method of (or definition for) calculating the parameter at the time of designing a network composition. Examples of the value of the parameter value calculation method 5216 include “fix”, “pool”, “pool (input subnet)”, and “refer”. The “fix” is a fixed value set in advance, and is defined by the tenant pattern information.

In FIG. 4, for example, the parameter “source” of the FW1 has a fixed value of “Any”. The ID pool defined by the ID pool information 524 is input as the “pool”, and an unused ID is assigned from the input ID pool and set as the value of the ID. It should be noted that the value assigned from the input ID pool is modified to the status “used” in the input ID pool. Further, in the ID pool, a logic about which ID is to be assigned when a request for assignment is received is input in advance. Examples of the logic for the assignment include “assign from minimum value” (assign in order from the minimum unused ID) and “random” (randomly assign from unused IDs). In FIG. 4, for example, the logic for the assignment of the parameter “ACL ID” of the FW1 is “assign from minimum value”. Therefore, the ID having the minimum value of the unused IDs is assigned to the parameter from a pool 6 of the ID. In FIG. 4, for example, the parameter “ACL ID” of the FW1 has the value assigned from the pool 6. In the “pool (input subnet)”, the unused IP address is assigned from the network address assigned to the input subnet and set as the value of the ID. It should be noted that the assigned value is modified to the state “used” in the input ID pool. In FIG. 4, for example, the parameter “IP address” of the core SW1 has the value assigned from the subnet 3 and has the status modified in an ID pool 3. The “refer” indicates that the values of the parameter of another node, subnet information, and the composition information 529 are referred to and set as the value of this parameter. It should be noted that it is possible to use for this parameter not only the same value as the referred value but also a value obtained by a value determined based on the referred value, such as a value obtained by subjecting the referred value to a preset arithmetic operation or a value obtained by subjecting the referred value to a preset character string processing.

In FIG. 4, for example, for the parameter “destination” of the FW1, the network address of the subnet 3 is referred to, and the referred value is set as the value of the parameter. The operation flow (operation type) 5217 is information on the operation flow for which the design/configuration is carried out for each of configuration item and an operation type of the configuration item at that time. The operation type includes “add”, “modification”, and “delete”, and the command template corresponding to the input operation type is used to generate the configuration contents. In FIG. 4, for example, the operation flow (operation type) 5217 for the configuration item “ACL” of the FW1 is the operation flow “ACL modify” and the operation type “add”. Therefore, when the operator inputs the operation flow “ACL modify”, the management server 500 adds the ACL of the FW1, and uses the command template for addition to generate the configuration contents.

A plurality of operation flows are associated with one configuration item. In this manner, the plurality of operation flows can be defined by using one tenant pattern, and hence there is no need to generate different configuration file for each operation flow, which facilitates the work for generating and maintaining the information for the automatic design/configuration.

The command template 5218 is template information for generating the command for the configuration contents. Command templates for addition, modification, and deletion are registered.

FIG. 5 is an explanatory diagram of the tenant pattern information (subnet) 522 according to this embodiment.

The tenant pattern information (subnet) 522 includes, for example, a pattern ID 5221, a subnet ID 5222, “use VLAN” 5223, a VLAN ID pool 5224, a member node 5225, and an address pool 5226.

The pattern ID 5221 is information for uniquely identifying the tenant pattern within the network system. The subnet ID 5222 is information for uniquely identifying the subnet within the tenant pattern. The “use VLAN” 5223 is information indicating whether or not the subnet is realized by using the VLAN. When the “use VLAN” 5223 is “∘”, the VLAN is composed. On the other hand, when the “use VLAN” 5223 is “-”, the VLAN is not composed.

The VLAN ID pool 5224 is information on the ID pool for assigning VLAN IDs used in the subnet. The member node 5225 is information on the node belonging to the subnet. The address pool 5226 is information on the ID pool for assigning the network address used in the subnet.

As described above, logical device information is defined for each tenant pattern by the tenant pattern information (node) 521 of FIG. 4 and the tenant pattern information (subnet) 522 of FIG. 5, and the configuration item and operation flow (type of operation) of each node are managed in units of the tenant pattern. In the above-mentioned conventional example, a template is generated for each operation flow, but one of the features is that the configuration items of each node are managed by one pattern.

FIG. 6 is an explanatory diagram of the mapping information 523 according to this embodiment.

The mapping information 523 includes, for example, a pattern ID 5231, a node 5232, a physical device/group 5233, “redundant” 5234, a default physical device/virtual SW 5235, a virtualized node 5236, and a selection method 5237.

The pattern ID 5231 is information for uniquely identifying the tenant pattern within the network system. The node 5232 is information for uniquely identifying the node within the network system. The physical device/group 5233 is information on the physical device (composition element) assigned to the node.

Further, in the case of performing the mapping to the group of the physical devices, the group is defined by this information. In FIG. 6, for example, the node “VM1” is mapped to the group 1 formed of the physical server 1 and the physical server 2. The “redundant” 5234 is information indicating whether or not the node of the tenant pattern is made redundant. The “redundant” 5234 being “∘” indicates making the node redundant. In FIG. 6, the node of the router 1 is composed of the router 1 and the router 2 being two physical devices, which indicates an example of realizing redundancy. On the other hand, when the “redundant” 5234 is “-”, the redundancy is not applied.

The default physical device/virtual SW 5235 is information for inputting a default physical device in a case where the selection method is “user input”, which is mapped to the group. It should be noted that, in the case where the node 5232 is the VM, the virtual SW to which the VM is connected is selected as the default physical device/virtual SW 5235. This is because it is probable that the VM for an entity has not deployed yet at the time of designing the network. Accordingly, the virtual SW generated by the virtualization module on the physical server 200 can be set as the default physical device/virtual SW 5235.

The virtualized node 5236 is information indicating whether or not the node is to be virtualized. In the case of the server, there are cases of being mapped to the physical server and being mapped to the VM, and the “virtualized node” being “∘” is handled as the VM. The selection method 5237 is a method of selecting the physical device from the group. Examples of the selection method 5237 include “user input” and “select physical server with least VM”. The “user input” represents that the physical device (virtual SW) input by the user at the time of the design is set as a mapping destination. The “select physical server with least VM” represents that the physical server 200 having the minimum number of VMs that have been deployed among a plurality of physical servers within the group is selected as the mapping (assignment) destination of the node. It should be noted that the selection method may be another method.

As described above, in the case of actually allocating the physical device from the tenant pattern information (node) 521 and the tenant pattern information (subnet) 522, the mapping information 523 can define presence/absence of virtualization or redundancy, the multiplicity of the node, and which group (or resource pool) the physical device is selected from.

FIG. 7 is an explanatory diagram of the ID pool information 524 according to this embodiment. The ID pool information 524 includes, for example, an ID 5241, a pool name 5242, a type 5243, a minimum ID 5244, a maximum ID 5245, a network address 5246, and a default mask length 5247.

The ID pool information 524 includes the addresses and the identifiers that are defined across the entire network system, and is shared by the plurality of tenant patterns. The ID 5241 is information on the identifier for uniquely identifying the ID pool. The pool name 5242 is name information on the pool corresponding to the ID. The type 5243 is information on the type of the ID pool. Examples of the type include “IP address” and “ID”. For the “IP address”, ID management (status management between used and unused) is performed at two stages in units of the network address and in units of the individual IP address. For the “ID”, the ID management (status management between used and unused) is performed in units of the ID.

The minimum ID 5244 indicates the value of the minimum ID within the pool. The maximum ID 5245 indicates the value of the maximum ID within the pool.

The network address 5246 is a network address assigned to the pool. The default mask length 5247 is a default subnet mask length at a time of assigning the network address. In FIG. 7, the network address that is first assigned from a pool 1 is “10.0.0.0/26”.

It should be noted that the management between used and unused of the ID or network address is to set a bitmap (not shown) for the IDs or network addresses of the respective IDs 5241. Then, the management server 500 sets a bit corresponding to the used ID or network address to “1” and sets a bit corresponding to the unused or returned ID or network address to “0”. In this manner, the assignment and collection of the ID and the network address are managed, and the already-used ID or network address is not used as the parameter, which allows an appropriate value to be calculated at all times while automating the calculation of the parameter.

FIG. 8 is an explanatory diagram of the command template information 525 according to this embodiment.

The command template information 525 includes, for example, an ID 5251, a name 5252, and a command template 5253. The command template information 525 is defined across the entire network system and shared by the plurality of tenant patterns.

The ID 5251 is information for uniquely identifying the command template within the network system. The name 5252 is name information on the command template. The command template 5253 is information for storing the command template. The command template allows a parameter to be substituted into the command (or command string), and the management server 500 substitutes the parameter into the command of the command template 5253 to thereby complete the command. In the example of FIG. 8, for example, the command template of the “delete ACL” for the ID 5251 of “2” is “unset policy id <ID>”, and the management server 500 substitutes the parameter “ID” into <ID>. Then, the management server 500 executes the command template 5253 in which the parameter is set.

FIG. 9 is an explanatory diagram of the tenant instance information (node) 526 according to this embodiment.

The tenant instance information (node) 526 includes, for example, a tenant instance ID 5261, a node 5262, a node instance 5263, a configuration item 5264, a parameter 5265, and a parameter value 5266.

The tenant instance ID 5261 is information for uniquely identifying an instance of each tenant within the network system. The node 5262 is a node of the tenant pattern. The node instance 5263 is information on the node of the tenant instance. In the case of the redundant node and the VM for which the multiplicity is set, a plurality of node instances is generated for one node. In FIG. 9, for example, the node instances 5263 having the node 5262 of “router 1” are “router 1-1” and “router 1-2”. The two node instances indicate that the node 5262 of “router 1” has a redundant composition.

The configuration item 5264 stores an item to be configured for each node instance. The parameter 5265 stores the type of parameter for the configuration item 5264. The parameter value 5266 stores the value of the parameter calculated at the time of the design.

In FIG. 9, because the user sets the multiplicity to “3”, three node instances 5263 of “tVM1-1”, “tVM1-2”, and “tVM1-3” are generated as the node 5262 of “VM1”. On the other hand, the node “VM2” has the default multiplicity (multiplicity 5213 of FIG. 4), and one node instance 5263 of “tVM2-1” is generated therefor.

FIG. 10 is an explanatory diagram of the tenant instance information (subnet) 527 according to this embodiment.

The tenant instance information (subnet) 527 includes, for example, a tenant instance ID 5271, an ID 5272, a VLAN ID 5273, a member node 5274, a connection node 5275, and a network address 5276.

The tenant instance ID 5271 is information for uniquely identifying an instance of each tenant. The ID 5272 is information for uniquely identifying the subnet within the tenant instance. The VLAN ID 5273 is a VLAN ID assigned to the subnet. The member node 5274 is node information on the node belonging to the subnet. The connection node 5275 is a node selected to be connected to the member node 5274. The network address 5276 is a network address assigned to the subnet.

FIG. 11 is an explanatory diagram of the tenant instance information (mapping) 528 according to this embodiment. The tenant instance information (mapping) 528 is generated or updated by the connection information generation program 514 and the network device information collection program 513.

The tenant instance information (mapping) 528 includes, for example, a tenant instance ID 5281, a node 5282, and a mapped device 5283.

The tenant instance ID 5281 is information for uniquely identifying a tenant instance.

The node 5282 is node information on the node of a mapping source of the tenant instance. The mapped device 5283 is information on the device of the mapping destination of the tenant instance. It should be noted that the mapping destination of the VM includes, in addition to a tentative VM, information on the virtual SW to which the VM is connected and the physical server including the virtual SW. This is because there is a case where the VM is not deployed on the physical servers 200 at the time of designing the network.

FIG. 12 is an explanatory diagram of the composition information 529 according to this embodiment.

The composition information 529 includes, for example, a device 5291, a management IP address 5292, a Telnet account 5293, and an SNMP community name 5294.

The device 5291 is information for uniquely identifying a device within the network system. The management IP address 5292 is information on an IP address for management of an access destination used to collect information from the device and perform configuration. The Telnet account 5293 is a Telnet account and a password that serve as the authorization information used when the configuration is performed on the device. It should be noted that an SSH or the like may be used to access the physical device instead of the Telnet, and in that case, account information on the SSH is held. The SNMP community name 5294 is information on an SNMP community used when the information is collected from the device by SNMP.

FIG. 13 is an explanatory diagram of the connection information 530 according to this embodiment.

The connection information 530 includes, for example, a link ID 5301, a connected device 1 5302, a device 1 port ID 5303, a connected device 2 5304, and a device 2 port ID 5305.

The link ID 5301 is information for uniquely identifying a link between the physical devices or between the virtual devices within the network system. The connected device 1 (5302) is information for uniquely identifying one physical device or one virtual device that is connected to the link. The device 1 port ID 5303 is information for uniquely identifying a port of the one physical device that is connected to the link. The connected device 2 (5304) is information for uniquely identifying the other physical device or the other virtual device that is connected to the link. The device 2 port ID 5305 is information for uniquely identifying a port of the other physical device that is connected to the link. The connection information 530 can identify the port IDs of the ports to which the devices at a start point and an end point of one link are connected.

FIG. 14 is an explanatory diagram of the ring composition information (redundant network information) 531 according to this embodiment.

The ring composition information 531 includes, for example, a ring ID 5311, a composed device 5312, a master node 5313, a forwarding port ID 5314, and a blocking port ID 5315.

The ring ID 5311 is information for uniquely identifying a ring network within the network system. The composed device 5312 is information on a list of the physical devices belonging to the ring network. The master node 5313 is information on the device of a master node of the ring network. The forwarding port ID 5314 is information on the forwarding port of the master node. It should be noted that the forwarding port of the ring network is a port for transferring a packet in a steady state. The blocking port ID 5315 is information on a blocking port of the master node. It should be noted that the blocking port of the ring network is a port which does not transfer the packet in a steady state but transfers a packet when a failure is detected.

It should be noted that a redundant network is exemplified above by the case of composing the ring network, but another publicly-known or well-known redundant network such as a spanning tree may be applied.

FIG. 15 is an explanatory diagram of the design/configuration task information 532 according to this embodiment.

The design/configuration task information 532 includes, for example, an ID 5321, a design complete date 5322, a configuration complete date 5323, design contents 5324, a using pattern 5325, a tenant instance 5326, configuration contents 5327, and a status 5328.

The ID 5321 is information for uniquely identifying a design/configuration task. The design complete date 5322 is a date on which the design of the design/configuration task is completed. The configuration complete date 5323 is a date on which the configuration of the design/configuration task is completed. The design contents 5324 are design contents of the design/configuration task. The using pattern 5325 is a tenant pattern used by the design/configuration task. The tenant instance 5326 is information for uniquely identifying a tenant instance generated by the design/configuration task. The configuration contents 5327 are configuration contents generated by the design/configuration task.

In FIG. 15, the design/configuration task information 532 is described in natural language, and a command for configuration is held as well. The status 5328 is status information on the design/configuration task. For example, “designed” indicates that the design is completed while the configuration for an actual device has not been carried out, “configured” indicates that the configuration for the actual device is completed, and “configuration failed” indicates that the configuration for the actual device has failed.

FIG. 16 is an explanatory diagram of the scheduling information 533 according to this embodiment.

The scheduling information 533 includes, for example, an ID 5331, a configuration scheduled date 5332, a task ID 5333, and a status 5334. The scheduling information 533 is generated when the operator schedules a configuration scheduled date at the time of the design.

The ID 5331 is information for uniquely identifying the scheduling information. The configuration scheduled date 5332 is information on the scheduled date on which the design/configuration task is to be carried out. The task ID 5333 is information for uniquely identifying the design/configuration task to be executed by the schedule. The status 5334 is an execution status for the schedule. For example, “not configured” indicates the status before the configuration scheduled date and before the configuration is carried out, and “configured” indicates the status after the configuration scheduled date and after the configuration is carried out.

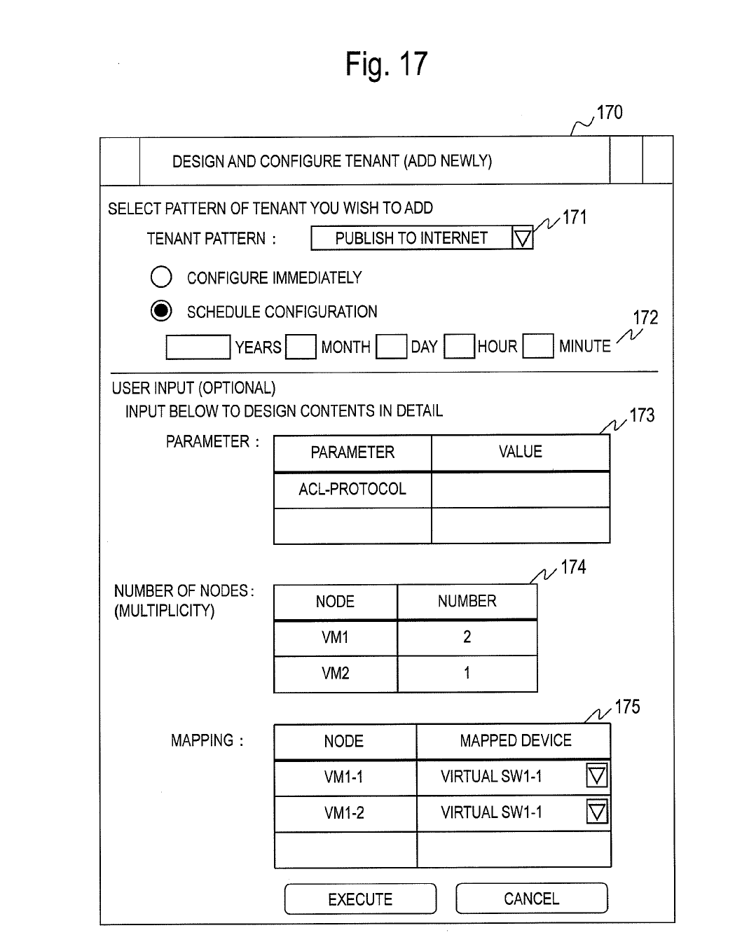

FIG. 17 is an explanatory diagram of a user interface 170 through which the operator who uses the management terminal 700 carries out the design or configuration of the network to add the tenant. The user interface 170 is a screen image displayed on the display of the management terminal 700.

The operator selects a pattern of the tenant to be added through the user interface 170 from a pull-down 171. Further, a timing for carrying out the configuration is selected from “configure immediately” and “schedule configuration”. In the case where “schedule configuration” is selected, a date 172 on which the configuration is to be executed is input. Unless there is no particular requirement, the above-mentioned items suffices as the information input by the operator, and the operator can design and configure the network without considering detailed contents relating to the network. In this manner, even the operator who is unfamiliar to the network can design and configure the network without an error.

Further, input fields for a parameter 173 defined as “user input” and a mapping 175 are displayed below “user input (optional)”. An item defined as the group in the physical device/group 5233 of the mapping information 523 is displayed in the input field for the mapping 175.

In FIG. 17, a “virtual SW 1-1” is displayed as the mapped device for the node “VM1-1”. In a case where the node is the VM, the virtual SW is selected in this manner. On the other hand, in a case where the node is other than the VM, a directly-corresponding device (if being the FW, the FW or the like) is displayed as an option.

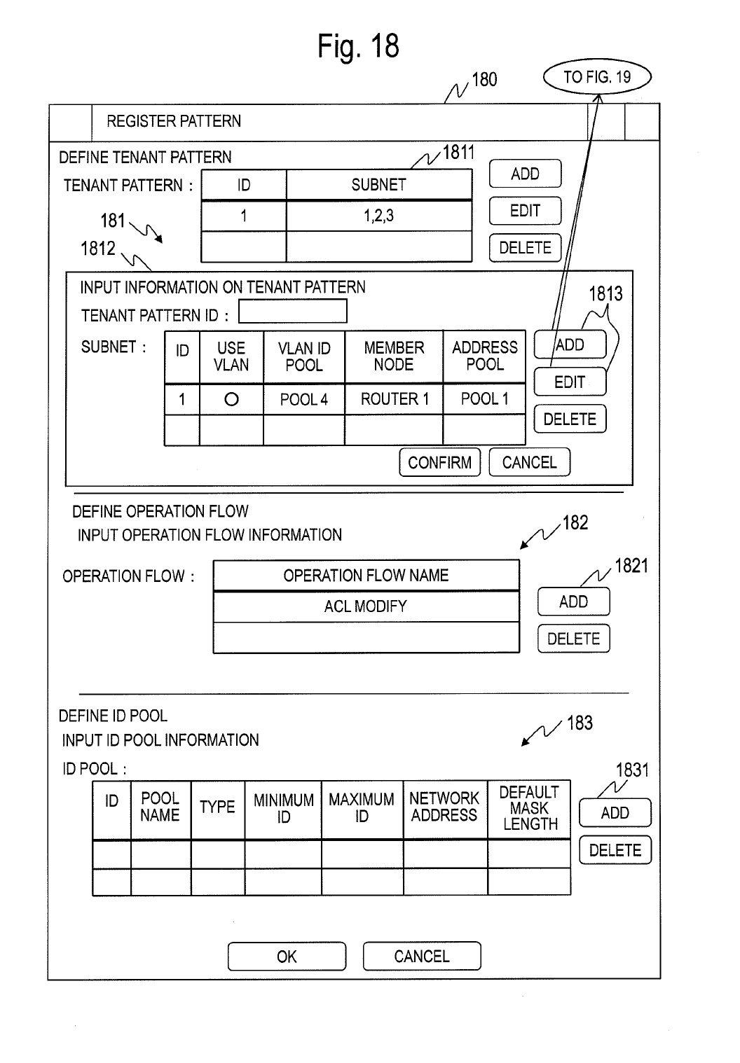

FIG. 18 illustrates a screen image of a user interface 180 through which a network designer who uses the management terminal 700 defines the tenant pattern.

The user interface 180 is normally used not by the operator who has a poor skill in the network but by a designer capable of designing the network when introducing the system and modifying the physical composition or the operation flow.

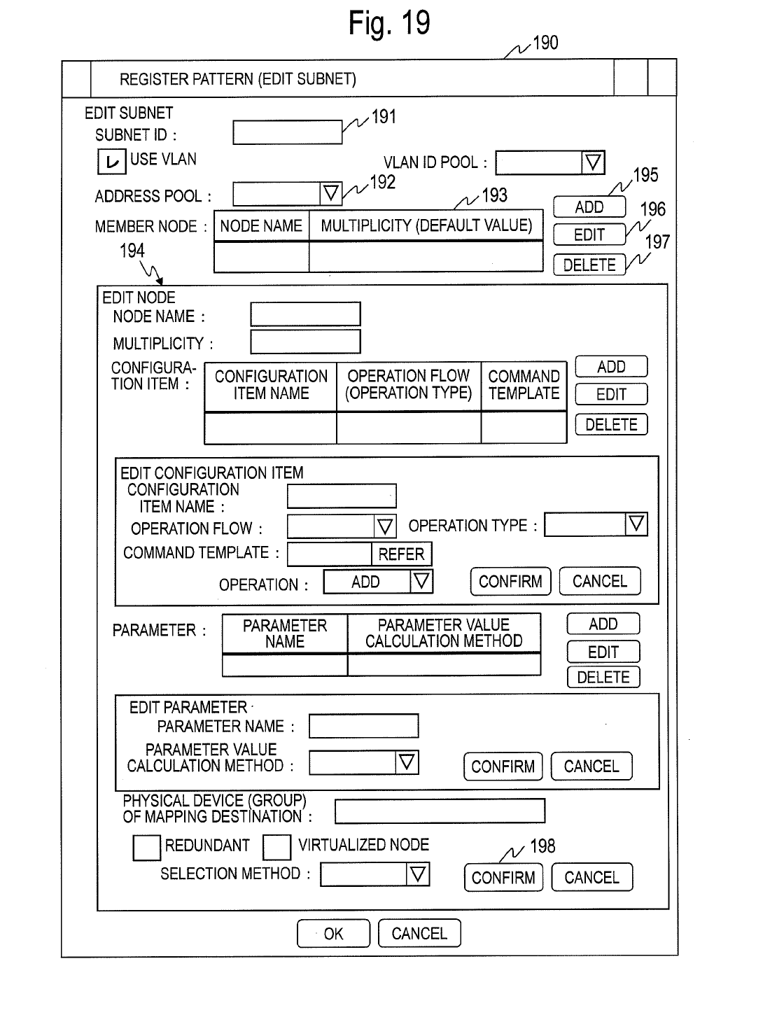

The user interface 180 is roughly divided into three parts: “define tenant pattern” 181; “define operation flow” 182; and “define ID pool” 183. In the area of “define tenant pattern” 181, there is a tenant pattern list 1811, and buttons that allow the addition, modification, and deletion of the tenant pattern are displayed. When the input device is operated to depress an add button, an input is received through a tenant pattern information input field 1812. By inputting information including a tenant pattern ID and the subnet into the input field 1812 and depressing a confirm button, the tenant pattern is added. When an add button and an edit button 1813 for a subnet list is depressed, transition is made to a “Register Pattern” (edit subnet) screen of FIG. 19. The “edit subnet” screen is described later referring to FIG. 19.

In the area of the “define operation flow” 182, an operation flow list is displayed. The operation flow registered in the area of “the define operation flow” 182 can be selected by the pull-down for the operation flow within “edit configuration item” of FIG. 19. When an add button 1821 is depressed, an entry is added to the list, and the operation flow name can be edited on the list. When a delete button is depressed, the operation flow selected in the list is deleted. Further, the modification is carried out by editing on the list.

In the area of the “define ID pool” 183, there is an ID pool list. When an add button 1831 is depressed, an entry is added to a list, and the ID pool information can be edited on the list. When a delete button is depressed, the ID pool selected in the list is deleted. Further, the modification is carried out by editing on the list.

Contents input through this screen are stored in the ID pool information 524.

FIG. 19 illustrates a screen image of a user interface 190 through which the network designer who uses the management terminal 700 defines the subnet of the tenant pattern. A subnet ID 191, an input field 192 for the ID pool used in the subnet, and the like are displayed. A node list 193 of the nodes belonging to the subnet is displayed, and when an add button 195 is depressed, and inputs are allowed in an “edit node” area 194. When the confirm button is depressed after the node name, the configuration item, the parameter, the mapping, and the like are input, the node information can be added.

When an edit button 196 is depressed, the information on the node selected in the list 193 is displayed in the “edit node” area 194, and values thereof can be edited. When a confirm button 198 is depressed after editing, the node information is modified. When the delete button 197 is depressed, the node selected in the list 193 is deleted. The configuration item and the parameter in an “edit node” field can be added, modified, and deleted in the same manner.

Contents input through this screen are stored in the tenant pattern information (node) 521, the tenant pattern information (subnet) 522, the mapping information 523, and the command template information 525.

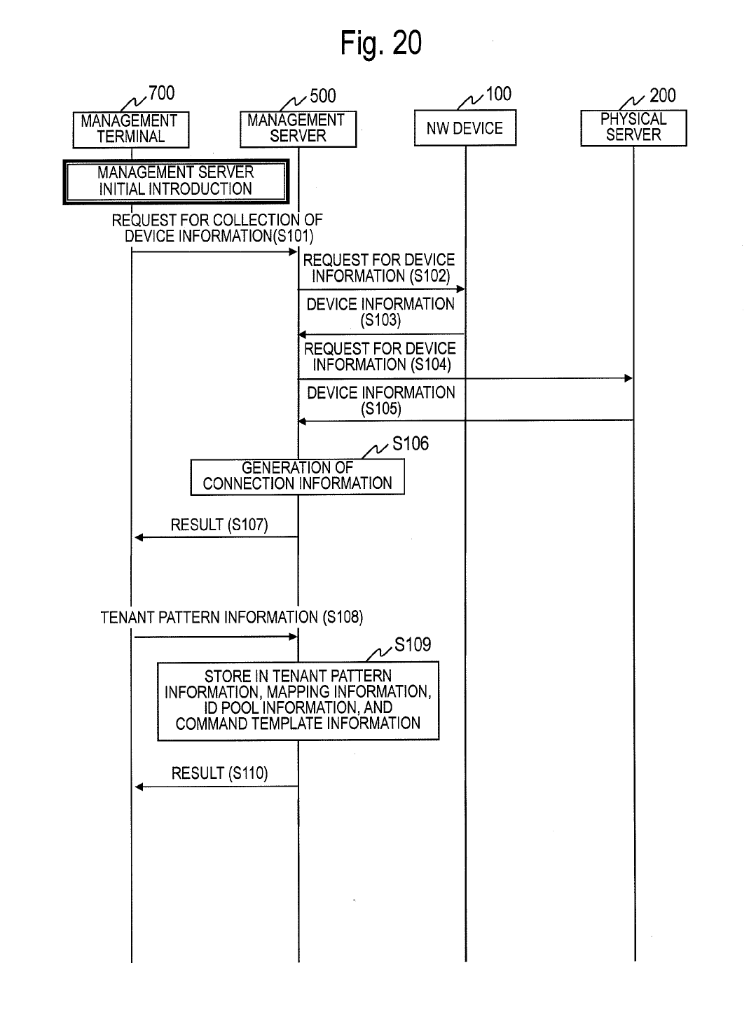

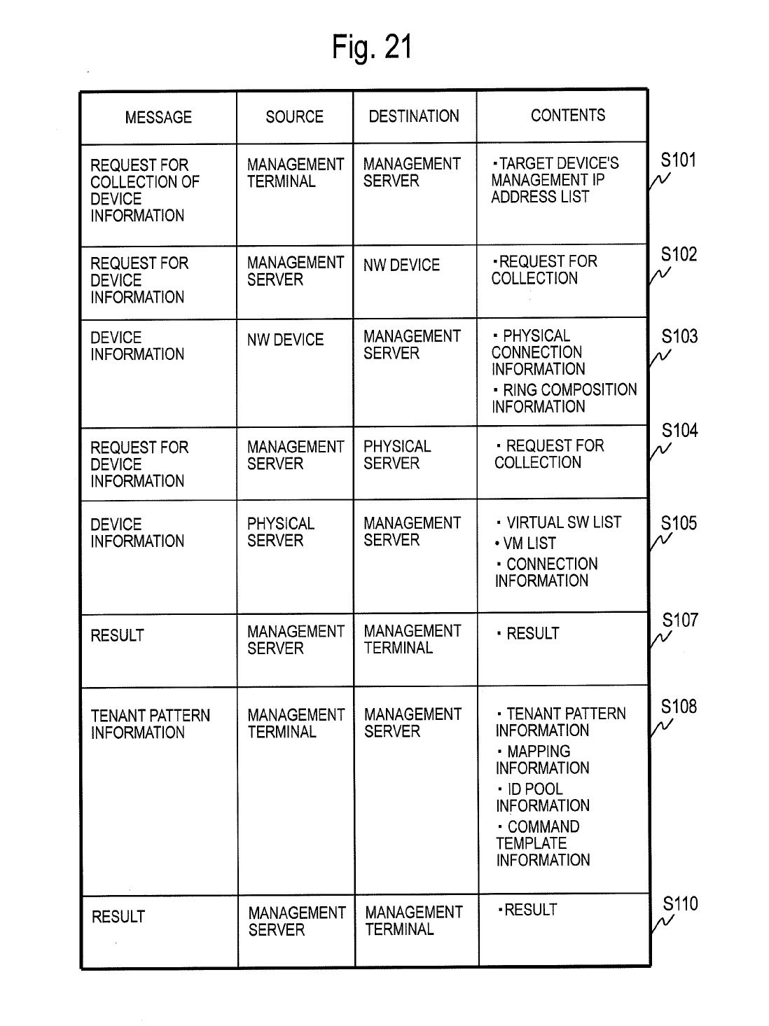

FIG. 20 is a sequence diagram used at a time of initial introduction of the management server 500 according to this embodiment. FIG. 21 is a diagram illustrating an example of a message transmitted/received at the time of the initial introduction of the management server according to this embodiment.

In FIG. 20, first, the management terminal 700 issues a request for collection of device information to the management server 500 (S101). When receiving the request, the management server 500 issues requests for the device information to the network device 100 and the physical server 200 that are the target devices included in the request (S102 and S104).

When receiving the request, the network device 100 transmits the connection information on a peripheral device owned by itself to the management server 500 along with, when a ring is composed, the ring composition information (S103). When receiving the request, the physical servers 200 transmits the virtual SW list, a VM list, and the connection information that are owned by itself to the management server 500 (S105).

The management server 500 generates the connection information between the physical devices or between the virtual devices from the connection information transmitted from the network device 100 and the physical server 200, and stores the connection information in the connection information 530 (S106). It should be noted that examples of connections between the physical devices or between the virtual devices include a connection between the edge switch 100G and the virtual switch 400A. The management server 500 notifies the management terminal 700 of results as to whether or not the collection of device information is successful, whether or not the generation of connection information is successful, and the like (S107).

The management terminal 700 transmits the tenant pattern information input from the user interfaces 180 and 190 illustrated in FIG. 18 and FIG. 19, respectively, to the management server 500 (S108).

The management server 500 stores the received tenant pattern information in the tenant pattern information (node) 521, the tenant pattern information (subnet) 522, the mapping information 523, the ID pool information 524, and the command template information 525, respectively (S109). The management server 500 notifies the management terminal 700 of a result as to whether or not the tenant pattern information has been successfully stored (S110).

Through the above-mentioned processing, the management server 500 newly introduced to the network system generates the connection information 530, the tenant pattern information (node) 521, the tenant pattern information (subnet) 522, the mapping information 523, the ID pool information 524, and the command template information 525, and stores the generated information in the memory 510 and the storage device 560.

It should be noted that, in the above-mentioned FIG. 20, the user interface of the management terminal 700 is used to input the tenant pattern information, but the tenant pattern information may be previously generated as a configuration file and may be read by the management server 500.

Further, the messages illustrated in FIG. 21 indicate the messages transmitted/received in the respective Steps S101 to S110 of the above-mentioned FIG. 20 along with the source, destination, and contents of the respective messages.

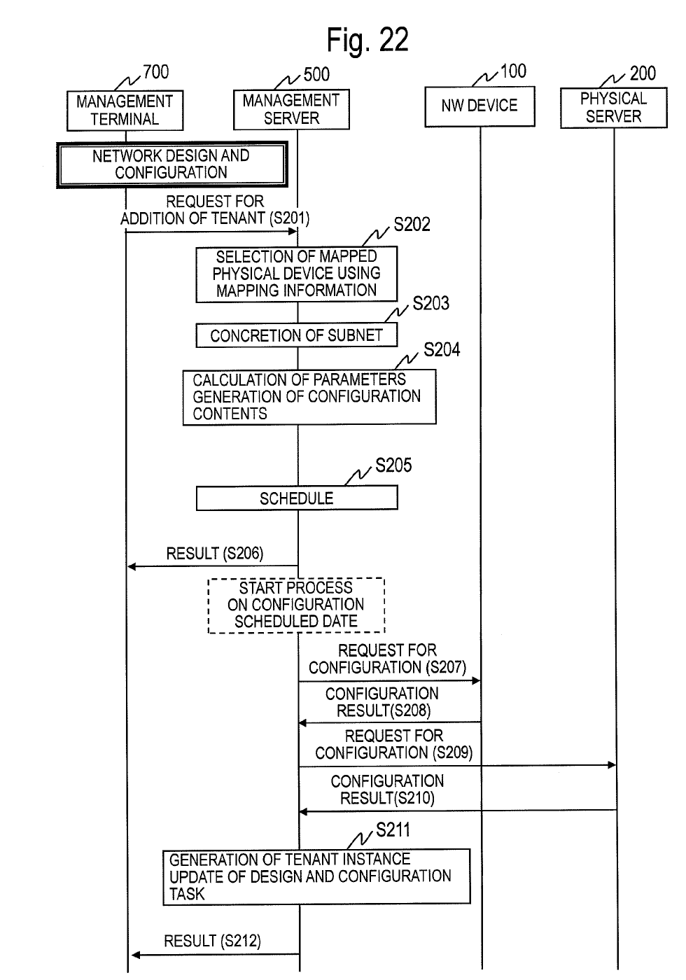

FIG. 22 is a sequence diagram of an example of adding the tenant during the operation of this embodiment in the network design and configuration.

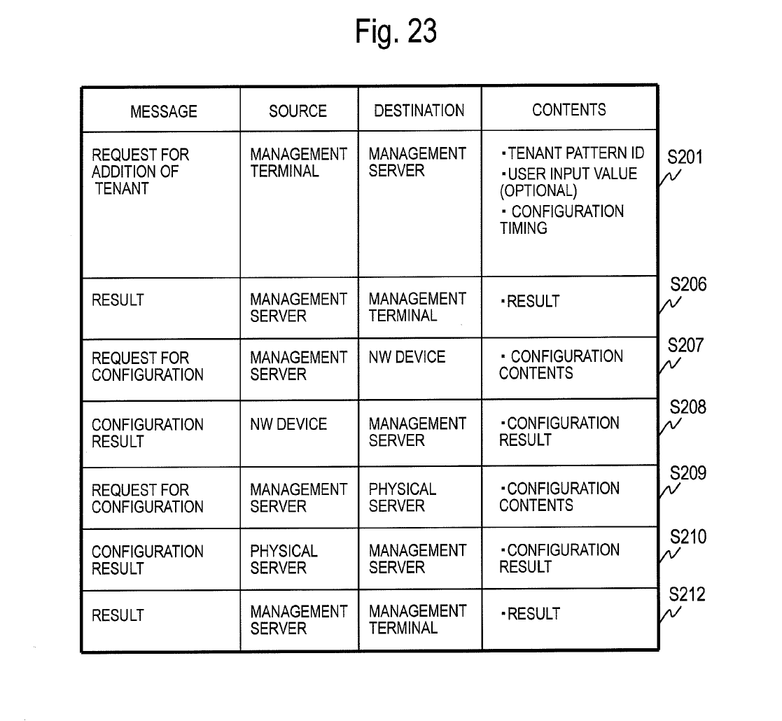

FIG. 23 is a diagram illustrating an example of a message transmitted/received when the network according to this embodiment is designed and configured.

In FIG. 22, first, the management terminal 700 issues a request for addition of tenant to the management server 500 (S201). The request includes the IDs of the tenant patterns to be used (pattern IDs 5211 and 5221 of the tenant pattern information (node) 521 and the tenant pattern information (subnet) 522, respectively) along with, in a case of the operator's input, a user input value and a configuration timing (whether or not to execute immediately or whether or not to schedule). Hereinafter, the tenant pattern information (node) 521 and the tenant pattern information (subnet) 522 are referred to generically as “tenant pattern”.

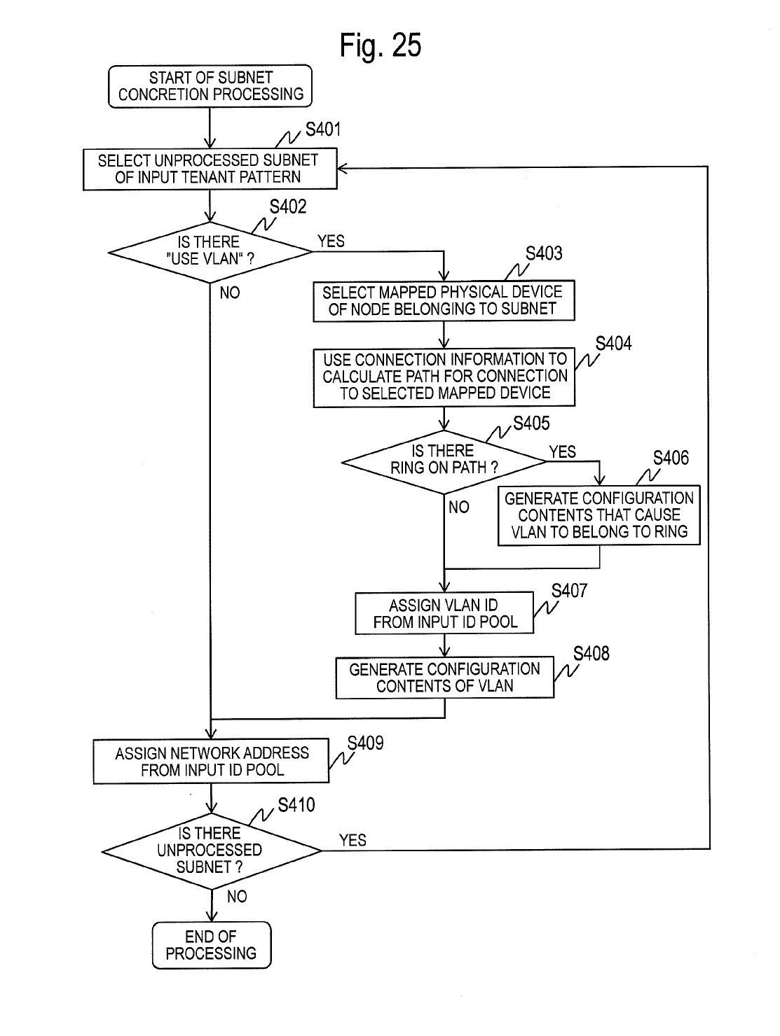

The management server 500 selects the mapped device corresponding to the tenant pattern by using the mapping information 523 (S202). This processing is described later in detail referring to FIG. 24. The management server 500 uses the selected information on the device to generate the configuration contents for concretion of the subnet (S203). This processing is described later in detail referring to FIG. 25.

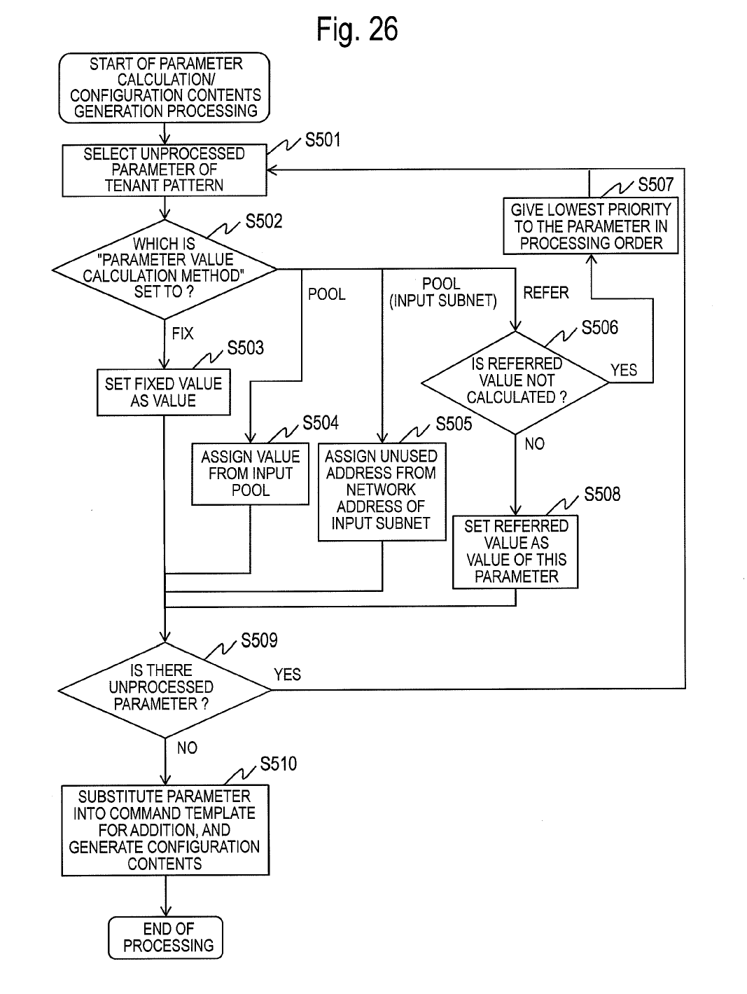

The management server 500 calculates the parameter for the node within the network system which is used when the tenant is added, and generates the configuration contents (S204). This processing is described later in detail referring to FIG. 26. When “scheduling” is input at the above-mentioned configuration timing, execution of the configuration of the physical device (or virtual device) is scheduled (S205). The management server 500 notifies the management terminal 700 of a result as to whether or not the design processing and scheduling processing are successful (S206).

The management server 500 starts configuration processing when the date input in the scheduling arrives, and issues requests for the configuration to the network device 100 and the physical server 200 (S207 and S209). When receiving the requests, the network device 100 and the physical server 200 update their own device information based on the configuration contents generated in Steps S203 and S204, and notify the management server 500 of the configuration results (S208 and S210). The management server 500 generates the tenant instance of the added tenant, and stores the tenant instance in the tenant instance information (node) 526, the tenant instance information (subnet) 527, and the tenant instance information (mapping) 528. Then, the management server 500 updates the status of the design/configuration task information 532 (S211). The management server 500 notifies the management terminal 700 of the result (S212).

Through the above-mentioned processing, at a timing corresponding to the schedule, the management server 500 adds a new tenant into the network system based on the ID of the tenant pattern input from the management terminal 700. At this time, only by inputting, by the operator of the management terminal 700, the ID of the tenant pattern and the operation flow (add), the design program 511 of the management server 500 can automatically calculate the configuration of the network composition and the physical device such as the physical server. Accordingly, even the operator who is unfamiliar to the network can easily acquire the configurations used for adding a new tenant. Then, on the input schedule, the configuration program 512 reflects the configuration of the new tenant on the physical device and the virtual device to thereby allow the new tenant to be added into the network system.

FIG. 24 is a flowchart of mapped device selection processing according to this embodiment. This flowchart illustrates an example of processing for selecting the mapped device by using the mapping information 523 which is performed in the above-mentioned Step S202 of FIG. 22.

The management server 500 refers to the tenant pattern information (node) 521 to select an unprocessed node from among the nodes of the tenant pattern input from the management terminal 700 (S301).

The management server 500 refers to the “redundant” 5234 of the mapping information 523 to determine whether or not there is “redundant” for the mapping of the selected node (S302). When there is “redundant”, the plurality of physical devices (or virtual devices) of the mapping destination are set as the mapped devices, and the configuration contents that cause the mapped devices to have the redundant composition are generated (S303).

For example, in FIG. 6, the node “router 1” indicates that there is “redundant”. There is a virtual router redundancy protocol (VRRP) as a redundancy method for the router, and redundancy configuration of the VRRP is generated for the mapped devices (router 1 and router 2). Specifically, the configuration of the VRRP is described in association with the router 1 of the node 5262 illustrated in FIG. 9. Herein, the VRRP is set as the redundancy method, but another redundancy method may be set. Further, the configuration contents corresponding to the redundancy can be generated not only for the router and the switch but also for appliance such as the FW. After that, the procedure advances to Step S310 of FIG. 24.

When there is no “redundant”, the management server 500 refers to the “physical device/group” 5233 of the mapping information 523 to determine whether or not the mapping to the group is set (S304).

When the mapping to the group is set, the management server 500 selects a tentative mapped device from within the group in accordance with the selection method defined by the “selection method” 5237 (S305). When the mapping to the group is not set, the physical device or the virtual device of the mapping destination is selected as the tentative mapped device (S306).

Subsequently, the management server 500 determines whether or not the currently selected node is the VM (S307). When being the VM, the management server 500 generates the tentative VM connected to the default virtual SW of the tentative mapped device or the virtual SW input by the user, and sets the tentative VM as the mapped device (S308). This is because the virtual SW to which the VM scheduled to be deployed is connected is selected instead due to the possibility that the VM may not be deployed at the time point of designing the network. It suffices that the network can be configured up to the virtual SW.

When the currently selected node is not the VM, the management server 500 selects the tentative mapped device as the mapped device (S309). Subsequently, the management server 500 determines whether or not there is an unprocessed node (S310). When there is an unprocessed node, the procedure returns to Step S301. When there is no unprocessed node, the procedure is brought to an end.

In this manner, the management server 500 can calculate the specifically corresponding physical device and virtual device at the time of designing the network composition for adding a new tenant. For this reason, a plurality of correlations can be defined by one mapping at a time point of defining the tenant pattern. Therefore, it is possible to easily perform the definition of the mapping and the maintenance.

FIG. 25 is a flowchart of subnet concretion processing according to this embodiment. This flowchart illustrates an example of processing for concretion of the subnet which is performed in the above-mentioned Step S203 of FIG. 22.

The management server 500 refers to the tenant pattern information (subnet) 522 illustrated in FIG. 5 to select an unprocessed subnet of the input tenant (S401). The management server 500 refers to the “use VLAN” 5223 illustrated in FIG. 5 to determine whether or not there is “use VLAN” for the selected subnet (S402). When there is no “use VLAN”, the procedure advances to the processing of Step S409. When there is “use VLAN”, the management server 500 selects the mapped device of the node belonging to the subnet selected in mapped device selection processing illustrated in FIG. 24 (S403).

The management server 500 refers to the connection information 530 to calculate a path for connection to the selected mapped device (S404). As an algorithm for calculating the path, for example, a publicly-known or well-known method such as the Dykstra method can be used. Subsequently, the management server 500 refers to the ring composition information 531 to determine whether or not a ring network is composed on the calculated path (S405). When a ring network is composed, the management server 500 generates the configuration contents that cause the VLAN to belong to the ring network (S406). After that, the procedure advances to the processing of Step S407. When a ring network is not composed, the management server 500 assigns the VLAN ID from the input ID pool (S407). The configuration contents for allocating the VLAN having the assigned VLAN ID to the mapped device are generated (S408).

Subsequently, the management server 500 assigns the network address to the currently selected subnet from the ID pool (S409). Subsequently, the management server 500 determines whether or not there is an unprocessed subnet (S410). When there is an unprocessed subnet, the procedure returns to the processing of Step S401. When there is no unprocessed subnet, the procedure is brought to an end.

In this manner, it is possible to calculate the device belonging to the subnet defined as a logical composition and to automatically generate the configuration contents of the VLAN that realizes the subnet, and hence the tenant pattern can be defined by a logical composition. Therefore, it is possible to easily perform the generation of the network composition at the time of adding the tenant and the maintenance of the network system.

FIG. 26 is a flowchart of parameter calculation/configuration contents generation processing according to this embodiment. This flowchart illustrates an example of processing for calculating parameters and generating the configuration contents which is performed in the above-mentioned Step S204 of FIG. 22.

The management server 500 refers to the tenant pattern information (node) 521 illustrated in FIG. 4 to select an unprocessed parameter of the tenant pattern (S501). The management server 500 selects the method of calculating the parameters from any one of “fix”, “pool”, “pool (input subnet)”, and “refer” depending on the type of the parameter value calculation method 5216 of the tenant pattern information (node) 521 (S502). When the parameter value calculation method is “fix”, a predetermined fixed value is set as the value of the parameter (S503). When the parameter value calculation method is “pool”, the value is assigned from the input pool. In that case, the value is assigned in accordance with the logic for the assignment (such as “assign from minimum value”) defined by the parameter value calculation method 5216 (S504). When the parameter value calculation method is “pool (input subnet)”, an unused IP address is assigned from the network address calculated in Step S409 of FIG. 25 and set as the value of the input subnet (S505). When the parameter value calculation method is “refer”, the management server 500 determines whether or not the referred value has not been calculated yet (S506). When the referred value has not been calculated yet, the lowest priority is given to the parameter in processing order (S507), and the procedure returns to the processing of Step S501. On the other hand, when the referred value has already been calculated, the management server 500 uses the referred value to set the referred value as this parameter (S508). After calculating the value as this parameter, the management server 500 determines whether or not there is an unprocessed parameter (S509). When there is an unprocessed parameter, the procedure returns to the processing of Step S501. When there is no unprocessed parameter, the parameter is substituted into the command template for the addition, and the configuration contents are generated (S510).

As described above, Steps S201 to S206 illustrated in FIG. 22 are processed by the design program 511 of the management server 500, and Steps S207 to S212 are processed by the configuration program 512 of the management server 500, thereby allowing automatic design and configuration of the network relating to the addition of the tenant. Accordingly, unlike the above-mentioned conventional example, there is no need to generate a large number of templates, and initial configuration of a network management system and the maintenance of the network system can be facilitated in units of the tenant pattern. In particular, it is possible for a daily operator to perform the design or configuration of the network with ease even without a skill in the network.

Then, as described above, if the operation flow is “add”, when receiving the tenant pattern, the management server 500 selects the physical device in accordance with the mapping information 523. Then, the management server 500 generates the subnet from the tenant pattern information (subnet) 522 and calculates an IP composition. Then, the management server 500 calculates the parameter regarding the configuration item of the tenant pattern information (node) 521 by a preset method, and substitutes the parameter into the command template 5253 to generate the configuration contents. When a predetermined timing input in the scheduling arrives, the configuration program 512 of the management server 500 executes the configuration contents and allocates the physical device and the virtual device to the tenant, to thereby start operation.

In this manner, a new tenant can be extremely easily added to the network system including the plurality of physical servers. Accordingly, in the data center for providing a computer resource such as a private cloud on demand, time and labor of the operator can be greatly reduced when the tenant is added.

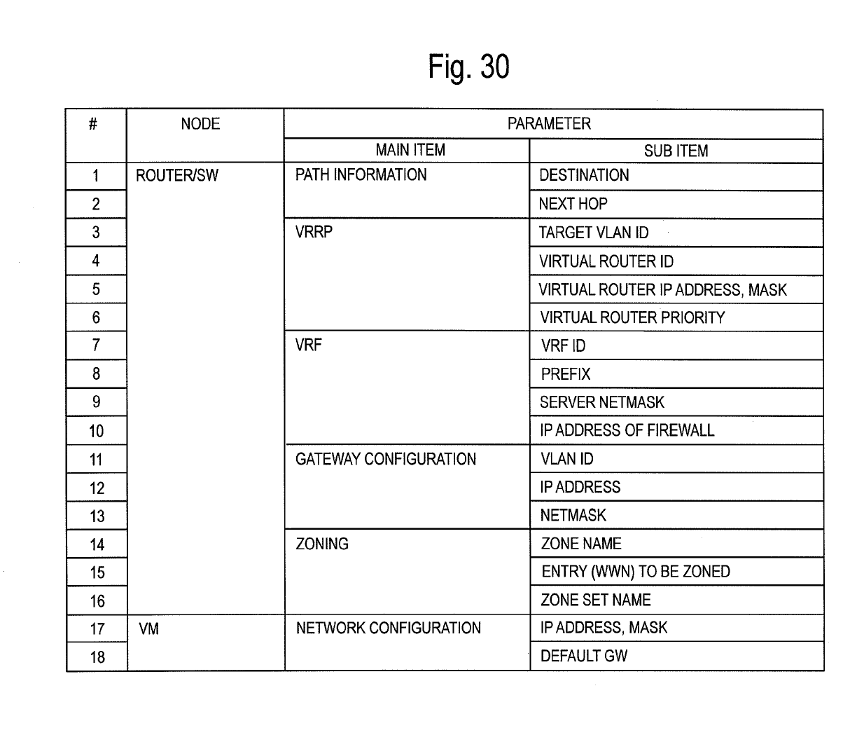

It should be noted that an example of the parameter is described with reference to the tenant pattern information (node) 521 of FIG. 4, but the configuration of the parameter is not limited to FIG. 4, and, for example, the items of the parameter may be classified into a main class and a sub class. FIG. 30 illustrates an example in which the items of the parameter are classified into the main class and the sub class. In the example of FIG. 30, the node of the router or the switch is composed of, as the main class of the parameter, path information, VRRP, virtual routing and forwarding (VRF), gateway configuration, zoning, and the like. Further, the example of FIG. 30 illustrates an example of the sub class subordinate to the main class being composed of the destination, the address, a zone name, an ID, and the like. In this manner, as the parameters of the tenant pattern information (node) 521, the items disclosed in FIG. 30 may be included in addition to the items disclosed in FIG. 4.

### Second Embodiment

A description is made of a second embodiment. In the second embodiment, the design and configuration for modifying an already designed and configured tenant instance are executed. Hereinafter, a description is given of a case of adding the VM, but the same processing applies to other modifications such as “add ACL” and “add VLAN” and the case of deleting the tenant instance.

In this manner, even in the case of modifying/deleting the tenant instance, the same tenant pattern definition and the same mapping information can be used as in the case of “add newly”, and there is no need to provide different settings for new addition, modification, and deletion, which facilitates the work for generating and maintaining the information for the automatic design/configuration.

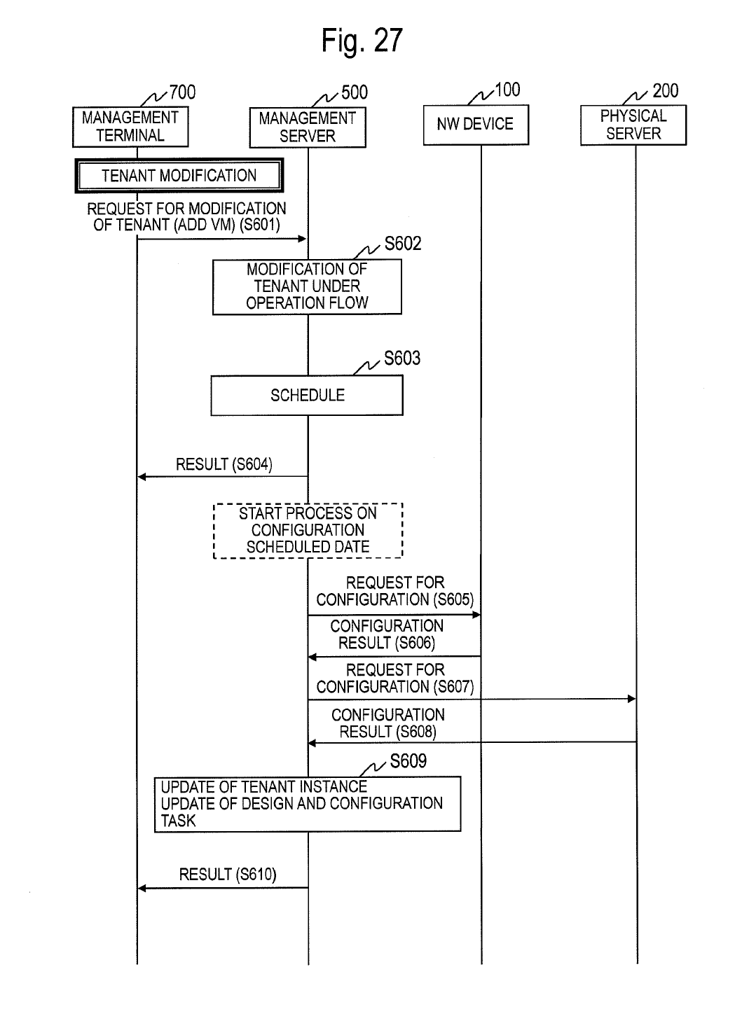

FIG. 27 is a sequence diagram used at a time of modifying the existing tenant (adding the VM) during the operation of this embodiment in the network design and configuration.

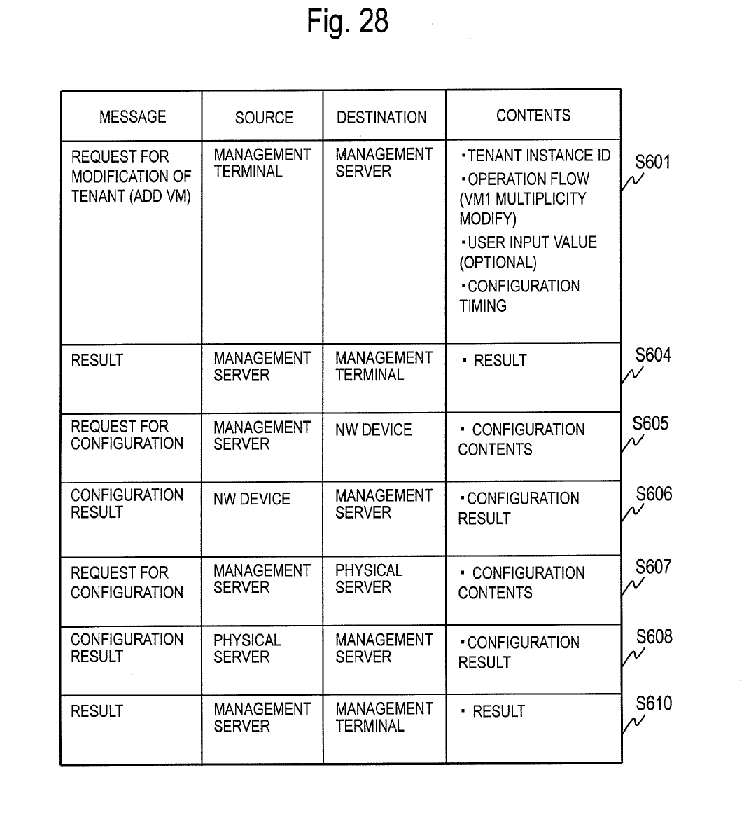

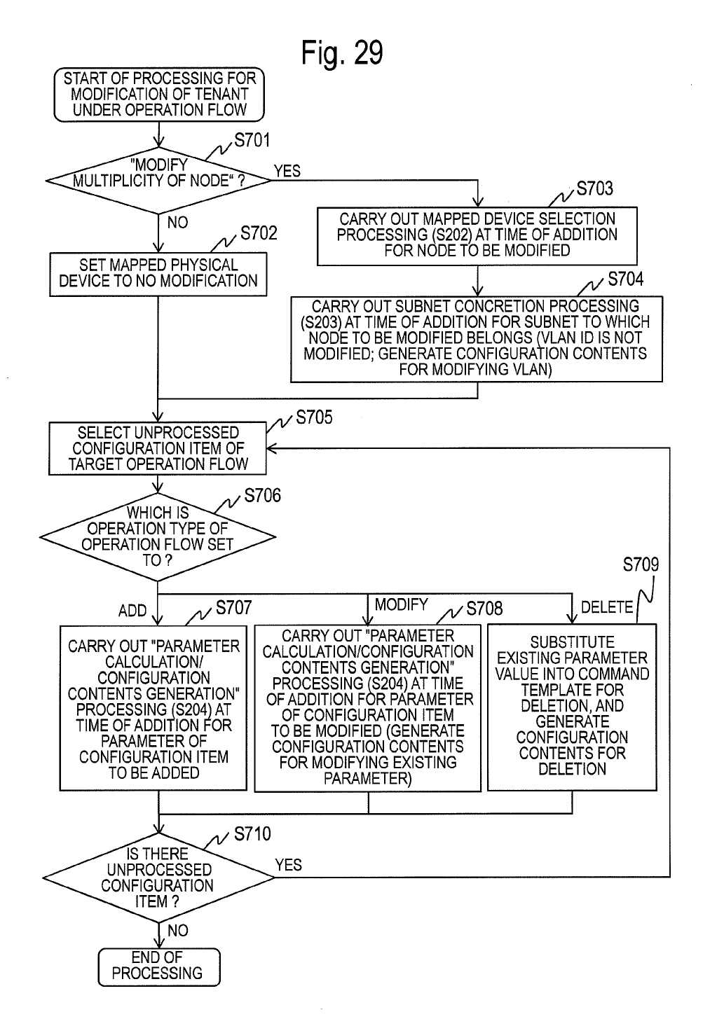

FIG. 28 is a diagram illustrating a message transmitted/received at the time of the network design and configuration according to this embodiment.

In FIG. 27, first, the management terminal 700 issues a request for modification of the tenant to the management server 500 (S601). The request includes the ID of the tenant instance to be modified and the operation flow representing modification contents along with, in the case of the operator's input, the user input value and the configuration timing (whether or not to execute immediately or whether or not to schedule).

The management server 500 performs processing for modification of the tenant under the operation flow (S602). This processing is described later in detail referring to FIG. 29. When “scheduling” is input at the configuration timing, the configuration of the physical device or the virtual device is scheduled (S603). The management server 500 notifies the management terminal 700 of the result as to whether or not the design processing and scheduling processing are successful (S604).

The management server 500 boots the configuration program 512 to start the configuration processing when the date input in the scheduling arrives, and issues requests for the configuration to the network device 100 and the physical server 200 (S605 and S607). When receiving the requests for configuration, the network device 100 and the physical server 200 update their own device information in accordance with the configuration contents, and notify the management server 500 of the configuration results (S606 and S608).

The management server 500 updates the modified tenant instance in accordance with the design contents, and stores the tenant instance in the tenant instance information (node) 526 and the tenant instance information (mapping) 528. Then, the management server 500 updates the status of the design/configuration task information 532 (S609). The management server 500 notifies the management terminal 700 of the result (S610).

Through the above-mentioned processing, when the management server 500 receives a modification request for the tenant, it is possible to automatically modify the composition of the network devices 100 and the physical servers 200 under the operation flow in response to the modification request.

FIG. 29 is a flowchart of the processing for modification of the tenant under the operation flow according to this embodiment. This processing represents an example of the processing for modification of the tenant under the operation flow, which is performed in Step S602 of FIG. 28.

The management server 500 determines whether or not the modification content of the tenant instance is “modify multiplicity of node” (S701). When the modification content of the tenant instance is not “modify multiplicity of node”, the mapped device is set to no modification (S702). When the modification content of the tenant instance is “modify multiplicity of node”, the mapped device selection processing (S202) at the time of the addition which is illustrated in FIG. 22 is carried out for the node whose multiplicity is to be modified (S703). Subsequently, the management server 500 carries out the subnet concretion processing (S203) at the time of the addition which is illustrated in FIG. 22, for the subnet to which the node whose multiplicity is to be modified belongs (S704). At this time, the existing VLAN ID is used without assigning the VLAN ID in the processing of Step S407 of FIG. 25. When there is a change in the path in the processing of Step S408, the configuration contents are generated in order to modify the VLAN.

Subsequently, the management server 500 refers to the operation flow 5217 of the tenant pattern information (node) 521 of FIG. 4 to select an unprocessed configuration item from among the target operation flows (S705). The management server 500 causes the processing to branch off depending on the operation type of the selected operation flow (S706).

When the operation type is “add”, the management server 500 carries out the “parameter calculation/configuration contents generation” processing (S204) at the time of the addition which is illustrated in FIG. 22, for the parameter of the configuration item to be added (S707). When the operation type is “modification”, the management server 500 carries out the “parameter calculation/configuration contents generation” processing (S204) at the time of the addition which is illustrated in FIG. 22 for the parameter of the configuration item to be added (S708). In the processing of Step S510 illustrated in FIG. 26, the configuration contents for modifying the existing parameter are generated. When the operation type is “delete”, the management server 500 substitutes the existing parameter value into the command template for deletion, and the configuration contents for the deletion are generated (S709). The management server 500 determines whether or not there is an unprocessed configuration item (S710). When there is an unprocessed configuration item, the procedure returns to the processing of Step S705. When there is no unprocessed configuration item, the procedure is brought to an end.

Through the above-mentioned processing, only by inputting the tenant pattern (the tenant pattern information (node) 521) and the operation flow 5217 (modification), the operator of the network system can extremely easily modify the configuration of the network devices 100 and the physical servers 200. Accordingly, in the data center for providing a computer resource such as a private cloud on demand, time and labor of the operator required for the modification can be greatly reduced.

As described above, according to the first and second embodiments, the tenant pattern information (node) 521 and the tenant pattern information (subnet) 522, in which the logical composition of the nodes, the configuration items, and the operation flows are configured, and the mapping information 523, in which the correlation between the tenant pattern and the physical device is managed, are previously generated, and the ID of the tenant pattern and the operation flow 5217 are input from the management terminal 700 to the management server 500, which allows the management server 500 to automatically design and configure the composition modification for the physical device or the virtual device under the above-mentioned operation flow from the tenant pattern and the mapping information 523. In other words, if the operator who uses the management terminal 700 inputs the operation flow of the tenant pattern information (node) 521, the management server 500 can automatically design the configuration of the network device and the physical server and can reflect the design contents on the physical device or the virtual device at a predetermined timing. Accordingly, the operator of the network system can carry out the composition modification even without having detailed knowledge about the network system.

As described above, this invention can be applied to a management computer and a management method which perform the addition of the tenant and the composition modification in the network system in which the network device and the physical computer are connected to each other.

Although the present disclosure has been described with reference to example embodiments, those skilled in the art will recognize that various changes and modifications may be made in form and detail without departing from the spirit and scope of the claimed subject matter.

What is claimed is:

1. A management method for a network system,
the network system comprising:
a network device for transferring a packet;
a physical server connected to the network device; and
a management server, which includes a processor and a storage device and is connected to the physical server via the network device,
the management method being performed to allocate computer resources comprising the network device and the physical server to a plurality of tenants,
the management method comprising:
a first step of acquiring, by the management server, a physical composition element and a virtual composition element of the computer resource and generating device information;
a second step of acquiring, by the management server, a physical connection of the computer resource and a virtualized connection and generating connection information;
a third step of receiving, by the management server, a plurality of tenant patterns for holding a template of a configuration item for each logical node, a parameter of the configuration item, a definition for calculating the parameter, and a command, and storing the plurality of tenant patterns in the storage device;
a fourth step of storing, by the management server, mapping information in which a correlation between a node of each of the plurality of tenant patterns and a composition element of the device information is configured, in the storage device;
a fifth step of receiving, by the management server, an input of the plurality of tenant patterns and a type of an operation;
a sixth step of selecting, by the management server, the composition element of the device information for each node from the plurality of input tenant patterns and the mapping information;
a seventh step of generating, by the management server, configuration contents of a network from the plurality of input tenant patterns and the selected composition element;
an eighth step of acquiring, by the management server, the definition for calculating the parameter for the each node from the plurality of input tenant patterns, calculating the parameter for the each node, and generating configuration contents of the each node; and
a ninth step of configuring, by the management server, the generated configuration contents of the network and the generated configuration contents of the each node, for the selected composition element.

2. The management method for a network system according to claim 1, wherein:
the each of the plurality of tenant patterns comprises a multiplicity of the each node and a default value of the multiplicity; and
the sixth step comprises generating the node corresponding to one of a number for the multiplicity of the node and the default value and selecting the composition element of the device information for the each node from the mapping information.

3. The management method for a network system according to claim 1, wherein:
the mapping information comprises group information in which the node of the each of the plurality of tenants is associated with a group formed of a plurality of composition elements; and
the sixth step comprises selecting, when the group information is configured for the node, the composition element to which the node is to be allocated from the plurality of composition elements, and selecting the composition element of the device information for the each node using the mapping information.

4. The management method for a network system according to claim 1, wherein the sixth step comprises selecting, when the node is a virtual machine, the physical server in which a number of virtual machines already in operation is minimum from among the physical servers within a group information, and allocating the node.

5. The management method for a network system according to claim 1, wherein:
the mapping information comprises redundant information indicating that the node of the tenant is made redundant; and
the sixth step comprises causing, when the redundant information is configured for the node, the composition element to which the node is to be allocated to be redundant.

6. The management method for a network system according to claim 1, wherein:
the each of the plurality of tenant patterns comprises an identifier of a subnetwork and the node within the subnetwork of the identifier; and
the seventh step comprises generating the configuration contents of a virtual network for the node within the subnetwork for the input tenant pattern and the selected composition element.

7. The management method for a network system according to claim 6, wherein:
the management server further comprises redundant network information for causing the network device to be redundant; and
the seventh step comprises generating, when the node within the subnetwork that configures the virtual network is included in the redundant network information, the configuration contents for causing the virtual network to be effective in the redundant network.

8. The management method for a network system according to claim 1, wherein:
the each of the plurality of tenant patterns further comprises operation flow information in which a correlation between the configuration item of the node and an operation type is configured; and
the eighth step comprises acquiring the definition for calculating the parameter for the each node from the input tenant pattern for the configuration item associated with the operation flow information, calculating the parameter for the each node, and generating the configuration contents of the each node.

9. A network system, comprising:
a network device for transferring a packet;
a physical server connected to the network device, comprising a processor and a storage device; and
a management server, which includes a processor and a storage device and is connected to the physical server via the network device,
the management server allocating computer resources comprising the network device and the physical server to a plurality of tenants, wherein:
the management server comprises:
a device information generation module for acquiring a physical composition element and a virtual composition element of the computer resource and generating device information;
a physical connection information generation module for acquiring a physical connection of the computer resource and a virtualized connection and generating connection information;
a tenant pattern information storage module for receiving a plurality of tenant patterns comprising a template of a configuration item for each logical node, a parameter of the configuration item, a definition for calculating the parameter, and a command, and storing the plurality of tenant patterns in the storage device;
a mapping information storage module for receiving mapping information in which a correlation between a node of each of the plurality of tenant patterns and a composition element of the device information is configured, and storing the mapping information in the storage device;
a design module for receiving an input of the plurality of tenant patterns and a type of an operation, and generating configuration contents of a network and configuration contents of each node; and
a configuration module for configuring the generated configuration contents of the network and the generated configuration contents of the each node, for the composition element;
the design module selects the composition element of the device information for the each node from the plurality of input tenant patterns and the mapping information, generates the configuration contents of the network from the plurality of input tenant patterns and the selected composition element, acquires the definition for calculating the parameter for the each node from the plurality of input tenant patterns, calculates the parameter for the each node, and generates the configuration contents of the each node; and
the configuration module configures the generated configuration contents of the network and the generated configuration contents of the each node, for the selected composition element.

10. The network system according to claim 9, wherein:
the each of the plurality of tenant patterns comprises a multiplicity of the each node and a default value of the multiplicity; and
the design module generates the node corresponding to one of a number for the multiplicity of the node and the default value and selects the composition element of the device information for the each node from the mapping information.

11. The network system according to claim 9, wherein:
the mapping information comprises group information in which the node of the each of the plurality of tenants is associated with a group formed of a plurality of composition elements; and
the design module selects, when the group information is configured for the node, the composition element to which the node is to be allocated from the plurality of composition elements, and selects the composition element of the device information for the each node using the mapping information.

12. The network system according to claim 9, wherein the design module selects, when the node is a virtual machine, the physical server in which a number of virtual machines already in operation is minimum from among the physical servers within a group information, and allocates the node.

13. The network system according to claim 9, wherein:
the mapping information comprises redundant information indicating that the node of the tenant is made redundant; and
the design module causes, when the redundant information is configured for the node, the composition element to which the node is to be allocated to be redundant.

14. The network system according to claim 9, wherein:
the each of the plurality of tenant patterns comprises an identifier of a subnetwork and the node within the subnetwork of the identifier; and
the design module generates the configuration contents of a virtual network for the node within the subnetwork for the input tenant pattern and the selected composition element.

15. The network system according to claim 14, wherein:
the management server further comprises redundant network information for causing the network device to be redundant; and
the design module generates, when the node within the subnetwork that configures the virtual network is included in the redundant network information, the configuration contents for causing the virtual network to be effective in the redundant network.

16. The network system according to claim 9, wherein:
the each of the plurality of tenant patterns further comprises operation flow information in which a correlation between the configuration item of the node and an operation type is configured; and
the design module acquires the definition for calculating the parameter for the each node from the input tenant pattern for the configuration item associated with the operation flow information, calculates the parameter for the each node, and generates the configuration contents of the each node.

17. A management server, which includes a processor and a storage device and is connected to a physical server via a network device, for allocating computer resources comprising the network device and the physical server to a plurality of tenants, the management server comprising:
a device information generation module for acquiring a physical composition element and a virtual composition element of the computer resource and generating device information;
a physical connection information generation module for acquiring a physical connection of the computer resource and a virtualized connection and generating connection information;
a tenant pattern information storage module for receiving a plurality of tenant patterns comprising a template of a configuration item for each logical node, a parameter of the configuration item, a definition for calculating the parameter, and a command, and storing the plurality of tenant patterns in the storage device;
a mapping information storage module for receiving mapping information in which a correlation between a node of each of the plurality of tenant patterns and a composition element of the device information is configured, and storing the mapping information in the storage device;
a design module for receiving an input of the plurality of tenant patterns and a type of an operation, and generating configuration contents of a network and configuration contents of each node; and
a configuration module for configuring the generated configuration contents of the network and the generated configuration contents of the each node, for the composition element, wherein:
the design module selects the composition element of the device information for the each node from the plurality of input tenant patterns and the mapping information, generates the configuration contents of the network from the plurality of input tenant patterns and the selected composition element, acquires the definition for calculating the parameter for the each node from the plurality of input tenant patterns, calculates the parameter for the each node, and generates the configuration contents of the each node; and
the configuration module configures the generated configuration contents of the network and the generated configuration contents of the each node, for the selected composition element.
